(19) United States
(12) Patent Application Publication
(10) Pub. No.: US 2026/0285076 A1
(43) Pub. Date: Sep. 24, 2026

(54) IMAGE FORMING SYSTEM

(71) Applicant: CANON FINETECH NISCA INC., Saitama (JP)

(72) Inventors: Osamu KAYAMORI, Yamanashi (JP); Yusuke YAZAKI, Yamanashi (JP)

(21) Appl. No.: 19/685,148

(22) Filed: May 22, 2026

Related U.S. Application Data
(63) Continuation of application No. PCT/JP2025/039197, filed on Nov. 7, 2025.

(30) Foreign Application Priority Data
Nov. 8, 2024 (JP) 2024-196049
Nov. 6, 2025 (JP) 2025-187799

(51) Int. Cl. B42C 19/08; B26F 1/02; B42C 5/00; B42C 13/00; B42C 19/02; G03G 15/00

(52) U.S. Cl. CPC B42C 19/08; B26F 1/02; B42C 5/00; B42C 13/003; B42C 19/02; G03G 15/6544; G03G 15/6582; G03G 2215/00814; G03G 2215/00936

(57) ABSTRACT

An image forming system includes an image forming portion configured to form an image on a sheet, a linear perforation processing portion configured to perform a linear perforation processing of forming a linear perforation on the sheet on which the image has been formed by the image forming portion, a bookbinding processing portion configured to perform a bookbinding processing including binding and folding to a plurality of sheets including the sheet on which the linear perforation processing has been performed by the linear perforation processing portion, a square back processing portion configured to perform a square back processing of forming a square back portion on a spine of a booklet formed by the bookbinding processing portion, and an adjustment portion configured to adjust a position at which the linear perforation processing portion forms the linear perforation, based on an execution instruction for the square back processing.

### CROSS-REFERENCE TO RELATED APPLICATIONS

This application is a Continuation of International Patent Application No. PCT/JP2025/039197, filed Nov. 7, 2025, which claims the benefit of Japanese Patent Application No. 2024-196049 filed Nov. 8, 2024 and Japanese Patent Application No. 2025-187799 filed Nov. 6, 2025, those of which are hereby incorporated by reference herein in their entirety.

### BACKGROUND

### Field of the Technology

The present disclosure relates to an image forming system configured to sequentially process a sheet on which an image has been formed and to form a booklet.

### Description of the Related Art

Image forming systems usually have a plurality of postprocessing apparatuses connected to a downstream side of an image forming apparatus, i.e., printer, by which various types of postprocessing, i.e., inline processing, may be performed.

One of the postprocessing apparatuses mentioned above is an apparatus that performs a sheet bundling process, i.e., bookbinding processing, by subjecting the sheet bundle to a stapling process and a folding process.

Further, Japanese Patent Application Laid-Open Publication No. 2015-168234 describes a technique in which the sheets to be subjected to sheet bundling are subjected to a linear perforating processing, by which a part of a page is enabled to be cut off by hand. There is a need for such a product to be used as coupons, cards, and tickets obtained by cutting a portion of a page of a booklet along the linear perforation.

Also, in the field of commercial printing, there is known a postprocessing called a square back processing in which a square back portion is created to a back of a booklet subjected to bookbinding, such that a booklet having a large number of sheets is prevented from opening arbitrarily when laid (refer to Japanese Patent Application Laid-Open Publication No. 2025-34235). Specifically, when a plurality of booklets are stacked on a tray, the stack may be collapsed, such that there is a demand for a booklet that is prevented from opening arbitrarily by being subjected to the square back processing.

### SUMMARY

According to the apparatus disclosed in Japanese Patent Application Laid-Open Publication No. 2015-168234 described above, a booklet subjected to a linear perforation processing was obtained. There is a need to meet the market demand to further subject the booklet to the square back processing as disclosed in Japanese Patent Application Laid-Open Publication No. 2025-34235 described above.

According to a first aspect of the present disclosure, an image forming system includes an image forming portion configured to form an image on a sheet, a linear perforation processing portion configured to perform a linear perforation processing of forming a linear perforation on the sheet on which the image has been formed by the image forming portion, a bookbinding processing portion configured to perform a bookbinding processing including binding and folding to a plurality of sheets including the sheet on which the linear perforation processing has been performed by the linear perforation processing portion, a square back processing portion configured to perform a square back processing of forming a square back portion on a spine of a booklet formed by the bookbinding processing portion, and an adjustment portion configured to adjust a position at which the linear perforation processing portion forms the linear perforation, based on an execution instruction for the square back processing.

According to a second aspect of the present disclosure, an image forming system includes an image forming portion configured to form an image on a sheet, a perforating processing portion configured to perform a perforation processing of forming a perforation on the sheet on which the image has been formed by the image forming portion, a bookbinding processing portion configured to perform a bookbinding processing including binding and folding to a plurality of sheets including the sheet on which the perforating processing has been performed by the perforating processing portion, a square back processing portion configured to perform a square back processing of forming a square back portion on a spine of a booklet formed by the bookbinding processing portion, and an adjustment portion configured to adjust a position at which the perforating processing portion forms the perforation based on an execution instruction for the square back processing.

According to a third aspect of the present disclosure, an image forming system includes an image forming portion configured to form an image on a sheet, a creasing processing portion configured to perform a creasing processing of forming a crease on the sheet on which the image has been formed by the image forming portion, a bookbinding processing portion configured to perform a bookbinding processing including binding and folding to a plurality of sheets including the sheet on which a creasing processing has been performed by the creasing processing portion, a square back processing portion configured to perform a square back processing of forming a square back portion on a spine of a booklet formed by the bookbinding processing portion, and an adjustment portion configured to adjust a position at which the creasing processing portion forms the crease based on an execution instruction for the square back processing.

Further features of the present disclosure will become apparent from the following description of embodiments with reference to the attached drawings. In the drawings, the same or similar components are denoted with the same reference numbers.

### BRIEF DESCRIPTION OF THE DRAWINGS

FIG. 1 is a cross-sectional view illustrating an image forming apparatus equipped with a perforating apparatus.

FIG. 2 is a system block diagram of the image forming apparatus.

FIG. 3 is a cross-sectional view illustrating a perforating apparatus.

FIG. 4 is a block diagram illustrating the perforating apparatus.

FIG. 5 is an example of a perforating portion.

FIG. 6A is a view illustrating a perforation position on a first sheet and an Nth sheet, with the perforation hole position corrected.

FIG. 6B is a view illustrating a perforation position on an Nth sheet, with the perforation hole position corrected.

FIG. 7A is a view illustrating a perforation hole of the booklet subjected to the perforating processing, without correction of the perforation hole position.

FIG. 7B is a view illustrating a perforating processing and a perforation hole of a booklet subjected to a half-folding processing, without the perforation hole position corrected.

FIG. 8A is a view illustrating a perforation hole of the booklet subjected to the perforating processing, without correction of the perforation hole position.

FIG. 8B is a view illustrating the perforation hole of a booklet subjected to a half-folding processing, with the perforation hole position corrected.

FIG. 9 is a cross-sectional view of a finisher.

FIG. 10 is a perspective view of a booklet subjected to the half-folding processing.

FIG. 11 is a block diagram of the finisher.

FIG. 12 is a perspective view of a square back processing portion.

FIG. 13 is a view illustrating a state of a side surface of the booklet subjected to the half-folding processing.

FIG. 14 is a view illustrating a state of a side surface of the booklet subjected to the half-folding processing and a square back processing.

FIG. 15 is a cross-sectional view of the square back processing portion.

FIG. 16A is a view illustrating a stop position (example 1) when performing the square back processing.

FIG. 16B is a view illustrating a state in which a square back portion has been formed by the square back processing.

FIG. 17A is a view illustrating a stop position (example 2) when performing the square back processing.

FIG. 17B is a view illustrating a state in which the square back portion has been formed by the square back processing.

FIG. 18 is a view illustrating a control flowchart of the present disclosure.

FIG. 19 is a flowchart of a process determining whether a square back processing may be executed according to the present disclosure.

FIG. 20 illustrates a setting screen of saddle stitch bookbinding.

FIG. 21 is a perspective view of a booklet subjected to the perforating processing and the half-folding processing.

FIG. 22 is a side view of the booklet subjected to the perforating processing and the half-folding processing.

FIG. 23 is a side view of the booklet subjected to the perforating processing, the half-folding processing, and the square back processing, without the perforation position corrected.

FIG. 24 is a side view of the booklet subjected to the perforating processing, the half-folding processing, and the square back processing, with the perforation position corrected.

FIG. 25 is a flowchart of a perforation position adjustment (first time) according to the present disclosure.

FIG. 26 is a flowchart of a perforation position adjustment (second time) according to the present disclosure.

FIG. 27 is a flowchart of the bookbinding processing.

FIG. 28 illustrates a screen display of the bookbinding processing setting.

FIG. 29 illustrates a screen display of the bookbinding processing setting.

FIG. 30 is a flowchart of the bookbinding processing.

FIG. 31 illustrates a screen display of the bookbinding processing setting.

FIG. 32 illustrates a flowchart of the bookbinding processing.

FIG. 33A is a view illustrating a sheet subjected to a creasing process.

FIG. 33B is a view illustrating a sheet subjected to a punching process.

FIG. 33C is a view illustrating a sheet subjected to a linear perforation processing.

FIG. 34 is a view illustrating another embodiment of a screen display during a bookbinding setting.

FIG. 35A is a view illustrating a length from a fold of the bookbinding processing to a perforation position.

FIG. 35B is a view illustrating a displacement of the perforation position by being changed from the bookbinding processing to the square back processing.

### DESCRIPTION OF THE EMBODIMENTS

Embodiments of the present disclosure will be described below exemplary in detail with reference to the drawings. Dimensions, materials, shapes, and relative arrangements of components according to the embodiments described below may be modified arbitrarily according to the configurations and various conditions to which the present disclosure is applied. Therefore, unless denoted otherwise, the scope of the present disclosure is not limited to the disclosed embodiments.

### Image Forming Apparatus

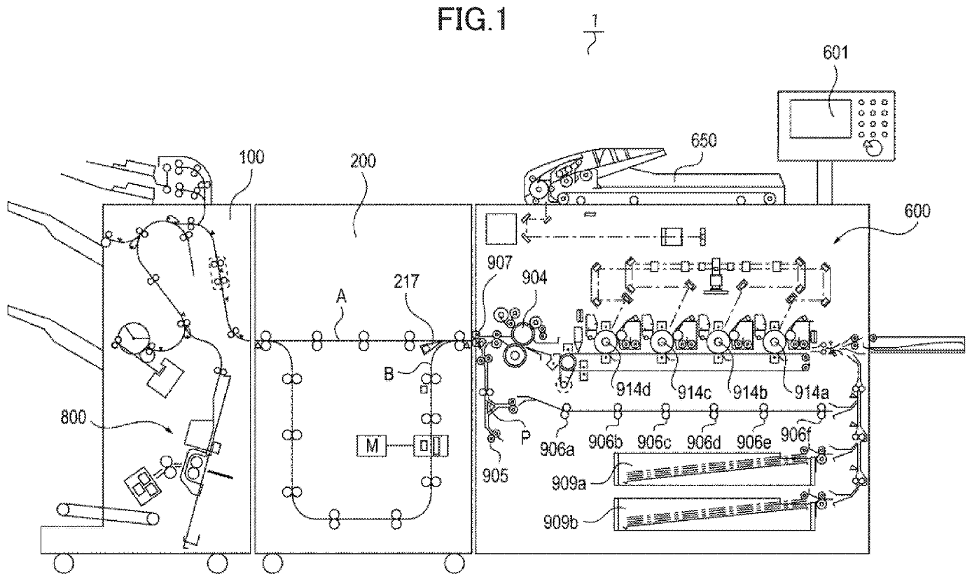

FIG. 1 is a configuration diagram illustrating an image forming system 1 according to the present embodiment. As illustrated in FIG. 1, the image forming system 1 includes an image forming apparatus 600 that forms black-and-white or color images, and a perforating apparatus 200 and a finisher 100, which serve as sheet processing apparatuses connected to the image forming apparatus body. Therefore, sheets discharged from the image forming apparatus 600 that serves as an image forming portion, an image forming devise or an image forming mechanism for forming images on a sheet may be processed by the perforating apparatus 200 and the finisher 100 that are connected in-line. The image forming apparatus 600 may also be used independently, without having the finisher 100 connected to a sheet discharge port thereof. Further, the image forming apparatus 600 may have the perforating apparatus 200 and the finisher 100 assembled thereto integrally as a sheet discharging apparatus. A position where the user faces an operation screen 601 that serves as a display portion when entering various inputs and settings to the image forming apparatus 600 is referred to as a front side of the image forming apparatus, and a rear side of the apparatus is referred to as a depth side. FIG. 1 illustrates a configuration of the image forming apparatus viewed from a front side of the apparatus. The perforating apparatus 200 and the finisher 100 are connected to a side portion of the image forming apparatus 600.

Toner images of four colors are transferred by photosensitive drums 914a to 914d of yellow, magenta, cyan, and black that respectively compose an image forming portion to a sheet S supplied from cassettes 909a and 909b inside the image forming apparatus 600. The sheet S onto which a toner image has been transferred is conveyed to a fixing unit 904 where the toner image is fixed, and ina simplex image forming mode, the sheet S is discharged in this state by a sheet discharge roller pair 907 to the exterior of the apparatus body. Further, in a duplex image forming mode, the sheet S is transferred from the fixing unit 904 to a reverse roller 905, and in a state where a trailing edge of the sheet in a conveyance direction of the sheet passes through a reverse switching portion P, the reverse roller 905 is rotated in the opposite direction to reverse the conveyance direction, and the sheet S is conveyed toward duplex conveyance rollers 906a to 906f. Thereafter, toner images of four colors, which are yellow, magenta, cyan, and black, are transferred to a back surface of the sheet by the photosensitive drums 914a to 914d. The sheet S having an image transferred to the back surface thereof is conveyed again to the fixing unit 904, where the toner image is fixed to the sheet S, and the sheet S is discharged by the sheet discharge roller pair 907 to the exterior of the apparatus body.

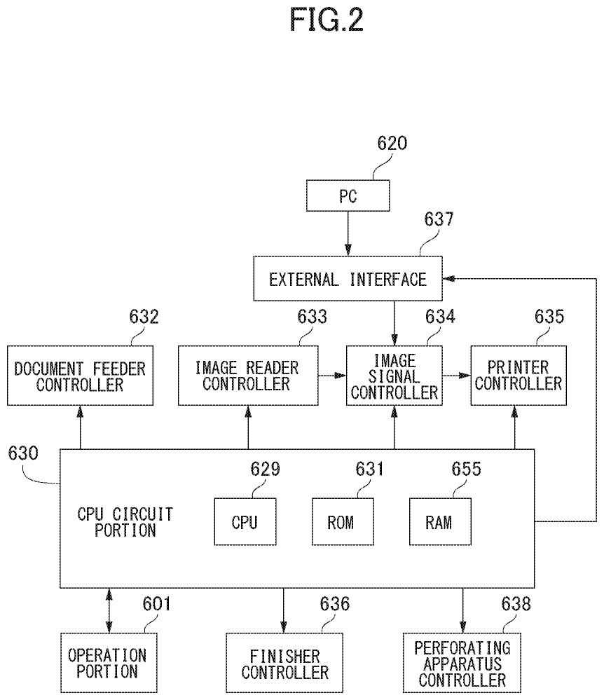

FIG. 2 is a block diagram of an image forming apparatus controller for controlling the image forming apparatus. As illustrated in FIG. 2, a CPU circuit portion 630 includes a CPU 629, a ROM 631 and a RAM 655. The CPU circuit portion 630 controls a document feeder controller 632, an image reader controller 633, an image signal controller 634, a printer controller 635, a finisher controller 636, a perforating apparatus controller 638, and an external interface 637. The CPU circuit portion 630 performs control of these controllers according to a program stored in the ROM 631 and a setting on the operation screen 601 serving as a display portion or a display devise. The document feeder controller 632 controls a document feeder 650. The image reader controller 633 controls an image reader. The printer controller 635 controls the image forming apparatus 600. The perforating apparatus controller 638 controls the perforating apparatus 200. The finisher controller 636 controls the finisher 100. The present embodiment is described based on a configuration where the perforating apparatus controller 638 is disposed on the perforating apparatus 200 and the finisher controller 636 is disposed on the finisher 100. However, the present disclosure is not limited thereto, and the CPU circuit portion 630 may be disposed integrally with the image forming apparatus 600, and the perforating apparatus 200 and the finisher 100 may be controlled from the image forming apparatus 600. Alternatively, the finisher 100 can be controlled by a controller disposed on the perforating apparatus 200, or the perforating apparatus 200 may be controlled by a controller disposed on the finisher 100.

The RAM 655 is used as an area for temporarily storing control data, and as a work area for performing arithmetic operation accompanying the control operation. The external interface 637 is an interface with a computer (PC) 620, and expands a print data into an image and outputs the same to the image signal controller 634. An image read by an image sensor is output from the image reader controller 633 to the image signal controller 634, and the image output from the image signal controller 634 to the printer controller 635 is entered to an exposure controller.

The perforating apparatus controller 638 is installed in the perforating apparatus 200, and by communicating information with the CPU circuit portion 630 of the image forming apparatus, drive control of the entire perforating apparatus is performed. The finisher controller 636 is installed in the finisher 100, and by communicating information with the CPU circuit portion 630 of the image forming apparatus, drive control of the entire finisher is performed. The perforating apparatus controller 638 and the finisher controller 636 control various motors and sensors.

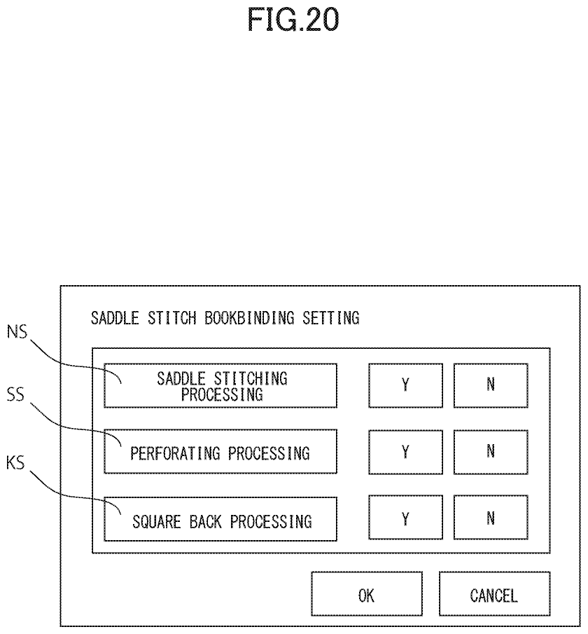

The user can enter various information and settings sch as a print job information on the operation screen 601. For example, a saddle stitch bookbinding setting as illustrated in FIG. 20 is displayed on the operation screen 601, and the user can select whether to perform a saddle stitch binding process NS, a perforating processing SS, and a square back processing KS, independently. The details of the saddle stitch binding process, the perforating processing, and the square back processing will be described later.

In the present embodiment, the operation screen 601 is described based on an operation panel, or touch panel, in which a display screen composed of a liquid crystal panel and operation buttons are integrated, and which is disposed on an image forming apparatus, but it is also possible to have an operation portion such as buttons disposed independently from the display screen. Alternatively, a removable tablet may be adopted. The display portion includes the CPU circuit portion 630 that outputs information to be displayed on the operation screen 601 which may output information to be displayed on a screen of a computer, i.e., PC, 620 via the external interface 637.

According to the present embodiment, the display screen was described based on a liquid crystal display system, but the present technique is not limited to liquid crystal displays. The present technique can adopt organic ELs.

Further according to the present embodiment, an example in which an image is formed on a sheet in an image forming apparatus adopting an electrophotographic system has been described, but the present technique is not limited thereto. For example, an inkjet system may be adopted. The electrophotographic system is preferable from the viewpoint of less deformation of sheets after image forming.

### Perforating Apparatus

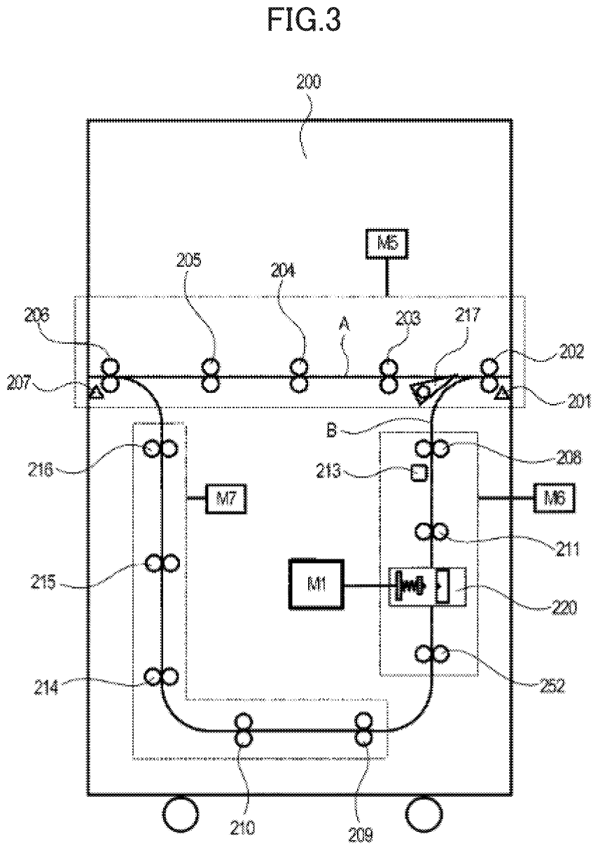

FIG. 3 is a cross-sectional view of the perforating apparatus 200 that functions as a linear perforation processing portion, a linear perforation processing devise or a linear perforation processing mechanism. As illustrated in FIG. 3, the perforating apparatus 200 receives sheets discharged from the image forming apparatus 600 sequentially, and is equipped with a perforation path B for performing a perforating processing to the sheet S being received, and a bypass A that transfers the sheet S to the finisher 100 disposed downstream thereof without subjecting the sheet to processing. The paths may be switched by a switching member 217.

The sheet processing in the perforating apparatus 200 is operated according to the setting of the user entered through the operation screen 601, i.e., display portion, provided on the image forming apparatus 600. The operation screen 601, i.e., display portion, adopts a user interface of the image forming apparatus, but it may also adopt a computer connected to an image forming system.

The sheet discharged from the image forming apparatus 600 is transferred to an inlet roller pair 202 of the perforating apparatus 200. In this state, a sheet transfer timing is simultaneously detected by an inlet sensor 201.

If the sheet is not subjected to a perforating processing, the sheet conveyance path is switched to the bypass A by the switching member 217, and the sheet is conveyed by conveyance roller pairs 203, 204, and 205 and a sheet discharge roller pair 206, and transferred to the finisher 100 disposed downstream thereof.

When subjecting the sheet to a perforating processing, the sheet conveyance path is switched to the perforation path B by the switching member 217, and the sheet is conveyed by conveyance roller pairs 208, 211, and 252 to a processing portion, where the sheet edge is detected by a sheet edge detection sensor 213. After stopping the sheet at a predetermined position in the conveyance direction, a perforating unit 220 is operated to perform the perforating processing to the sheet. The sheet subjected to the perforating processing is then conveyed again via conveyance roller pairs 209, 210, 214, 215, and 216 and the sheet discharge roller pair 206, and transferred to the finisher 100 disposed downstream thereof.

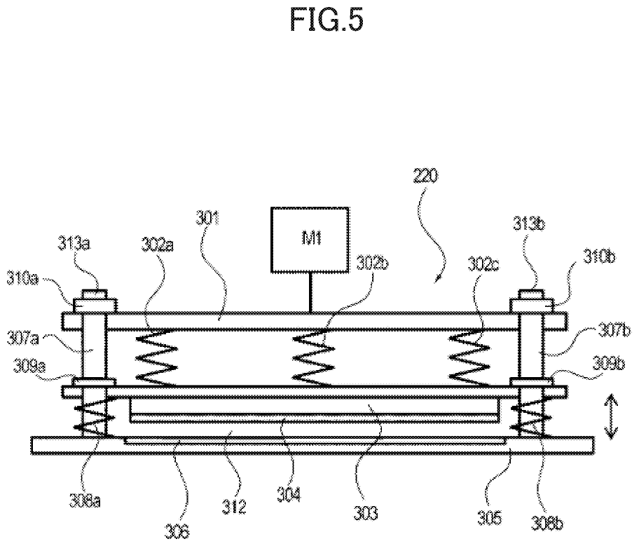

FIG. 5 is a cross-sectional view of the perforating unit 220 taken from a downstream side in a sheet conveyance direction. A die plate 305 includes a perforating groove 306. Shaft guides 307a and 307b are erected on the die plate 305, slidably supporting a movable plate 301 and a perforation forming blade holder 303. A perforation forming blade 304 is disposed on the perforation forming blade holder 303, and fits to the perforating groove 306 so as to execute the perforating processing. Pressing springs 302a, 302b, and 302c are disposed between the movable plate 301 and the perforation forming blade holder 303. By having the movable plate 301 pushed down by a driving motor M1, the pressing springs 302a, 302b, and 302c push down the perforation forming blade holder 303, and the perforation forming blade 304 is engaged with the perforating groove 306. Release springs 308a and 308b are springs that push up the perforation forming blade holder 303 being pushed down. A top dead center of the perforation forming blade holder 303 is a position where it is abutted against stoppers 309a and 309b, and a top dead center of the movable plate 301 is a position where it is abutted against stoppers 310a and 310b. The perforation forming blade 304 can be exchanged to those for arbitrary hole shapes, and therefore, enables change of size of the perforating punch or enables the processing to be changed to a linear perforation processing.

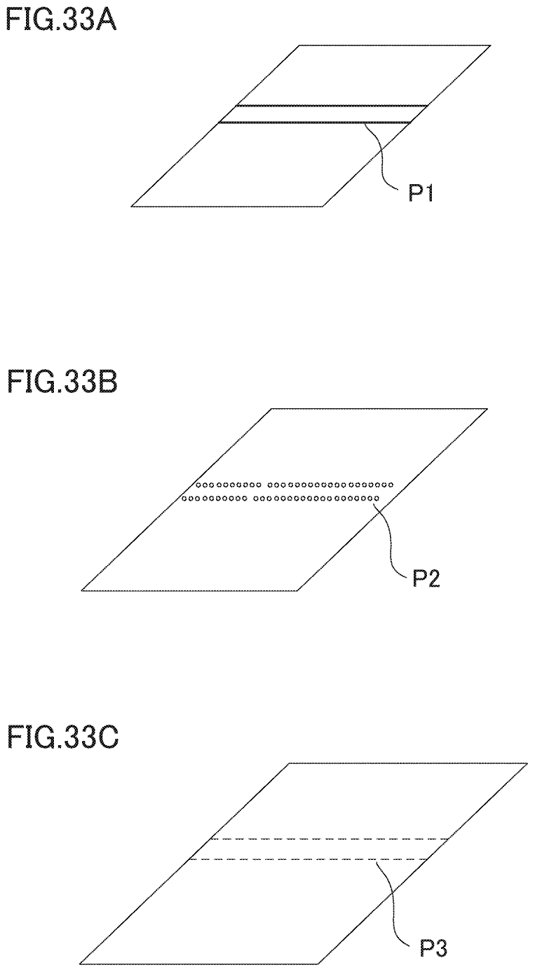

That is, according to the present embodiment, the perforating apparatus 200 described above is a processed portion forming portion that forms a processed portion on a sheet along a predetermined direction, for example, a direction along which a spine of a booklet is formed, which is a short side direction of a sheet according to the present embodiment, and serves as a perforating processing portion that can be changed to a linear perforation processing portion and a hole punching portion according to the shape of the perforation forming blade 304. For example, in a state where the perforating apparatus 200 functions as a linear perforation processing portion, a linear perforation P3 serving as a processed portion as illustrated in FIG. 33C is formed on the sheet. Further, in a state where the perforating apparatus 200 functions as a punching processing portion, punched holes P2 serving as the processed portion as illustrated in FIG. 33B are formed on the sheet. Further, the perforating apparatus 200 serving as a processed portion forming portion may serves as a creasing apparatus, a creasing processing portion, a creasing processing devise or a creasing processing mechanism that performs creasing, or a creasing process, to a sheet by changing the perforation forming blade 304 to a crease die. In that case, a crease P1 serving as a processed portion as illustrated in FIG. 33A is formed on the sheet.

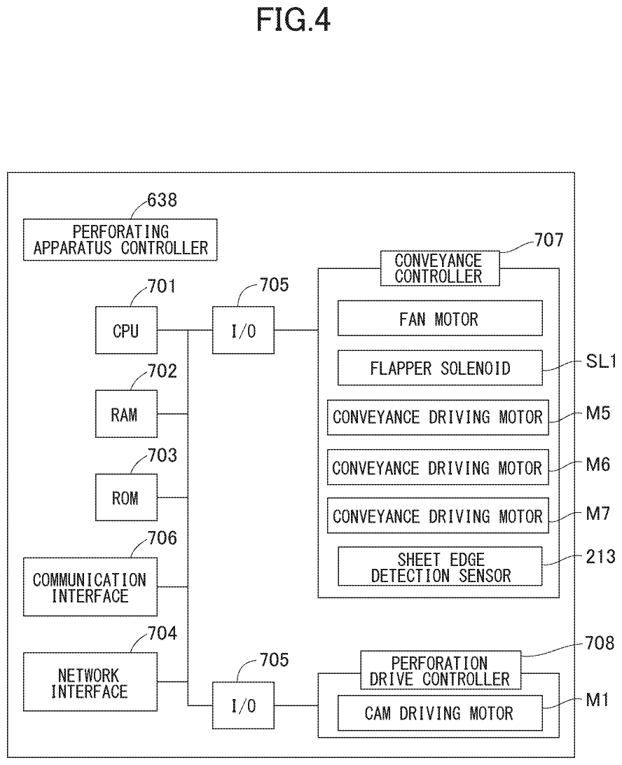

As illustrated in FIG. 4, the perforating apparatus controller 638 includes a microcomputer (CPU) 701, a RAM 702, a ROM 703, an input/output unit (I/O) 705, a communication interface 706, and a network interface 704. A conveyance controller 707 controls a solenoid SL1 that drives the switching member 217, conveyance driving motors M5, M6, and M7, the sheet edge detection sensor 213, and a fan motor that drives the fan. Further, a perforation drive controller 708 controls a perforation driving motor M1. Various sensor signals are entered to an input port of the I/O 705. An output port of the I/O 705 is connected to various drive systems that are connected via control blocks not shown or via various drivers not shown.

According to the present embodiment, the perforating unit 220 is configured to allow a perforation position to be modified with respect to an intermediate position in a longitudinal direction of the sheet, and the perforating unit 220 is configured to vary the perforation position per sheet within one set of sheets subjected to the perforating processing.

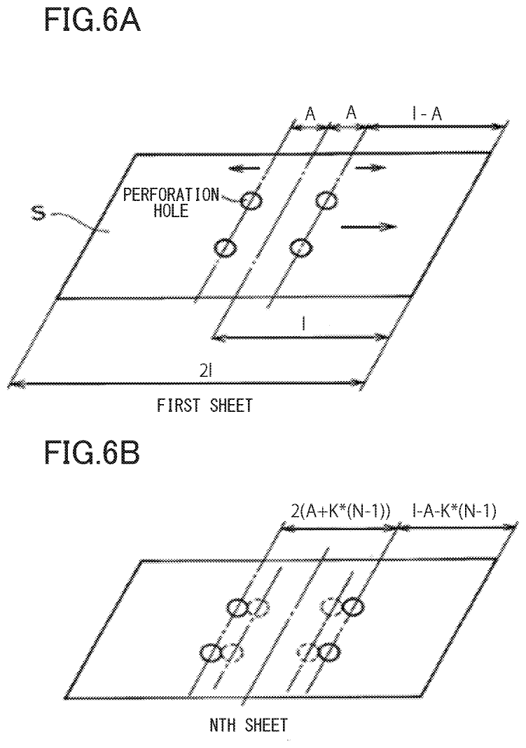

According to the perforating apparatus 200 configured as described above, as illustrated in FIGS. 6A and 6B, in a state where a leading edge of the sheet S is detected by the sheet edge detection sensor 213, a sheet leading-edge detection signal from the sheet edge detection sensor 213 is used as a trigger to convey the sheet S for a length (l-A) according to the sheet size, such that the sheet S is stopped at a position where the perforation forming blade 304 is positioned at a front side by a predetermined amount A from a position at a length l from the leading edge of the sheet S, which is an intermediate position of the sheet S in the longitudinal direction, the perforating processing (first time) is executed and a perforation is formed on the sheet S.

After the perforating processing (first time) has ended, the conveyance of the sheet S is restarted, and the sheet S is stopped again after the sheet S has travelled for a length (2A), where the perforating processing (second time) is performed and a perforation is formed on the sheet S. After the perforation process (second time) has ended, the conveyance of the sheet S is resumed.

In the perforating apparatus 200, a feed amount when performing the perforating processing to the sheet S is designed to be varied per sheet. For example, in a case where the sheet S is a normal paper, the thickness of the sheet S is approximately 0.1 mm, such that regarding the second sheet S, after detecting the leading edge of the sheet S by the sheet edge detection sensor 213, the sheet S is stopped at a position after the sheet S has travelled for a length (l−A−0.1), and the perforating processing (first time) is executed. After the perforating processing (first time) has ended, the conveyance of the sheet S is resumed, and the sheet S is stopped again at a position after the sheet S has travelled for a length (2A+0.2), and the perforating processing (second time) is executed to form a perforation on the sheet S.

When the above relationship is expressed as an equation, a conveyance amount X1 prior to the perforating processing (first time) can be expressed by X1=(l−A−0.1*(N−1)), assuming that the sheet S is the Nth sheet, and a sheet conveyance amount X2 after the perforating processing (first time) has ended until the subsequent perforating processing (second time) is executed can be expressed by X2=2(A+0.1*(N−1)). In a case where the sheet S is a thick paper, control corresponding to the sheet thickness is enabled by setting a coefficient K of (N−1) of the above equation to approximately 0.2 instead of 0.1.

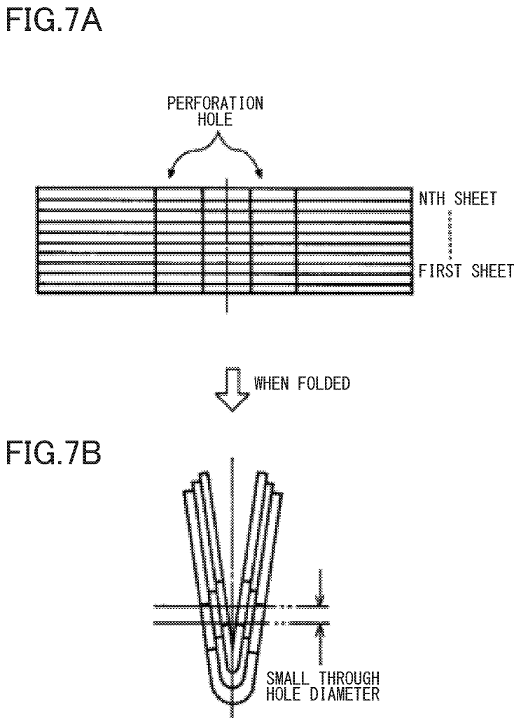

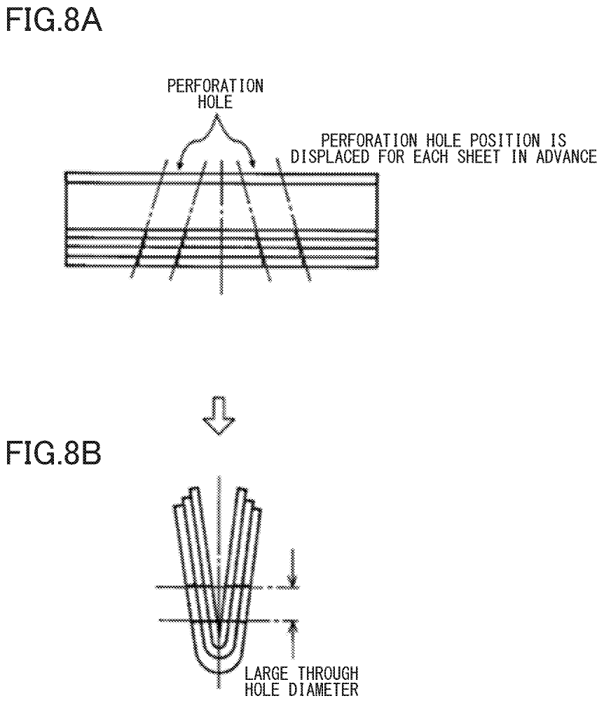

As a result, the perforating processing can be performed with high accuracy such that when a bundle of sheets S is subjected to a folding process after executing a saddle stitch binding process as needed to a bundle of sheets S subjected to the perforating processing by the perforating apparatus 220, the perforation position on each sheet S of the bundle of sheets that has been subjected to a folding process by which the sheet bundle has been folded in half can be arranged approximately linearly, as illustrated in FIGS. 8A and 8B (also refer to FIGS. 7A and 7B).

In the embodiment described above, the perforating apparatus that functions as a linear perforation processing portion is described as a system adopting a perforation forming blade and a die, but the present technique is not limited thereto. For example, a system that punches holes using a rotary blade may be adopted. However, the system using the perforation forming blade and the die is more preferable, since it has superior productivity.

### Description of Finisher

The finisher 100 receives sheets conveyed from the image forming apparatus 600 via the perforating apparatus 200, and processes the received sheets. For example, the finisher 100 aligns the plurality of sheets being received and performs processing of sheets, such as a process to bundle the sheets as a sheet bundle, a stapling process of stapling a trailing edge side of the sheet bundle, a sorting process, a non-sorting process, and a saddle stitch binding process to form a booklet.

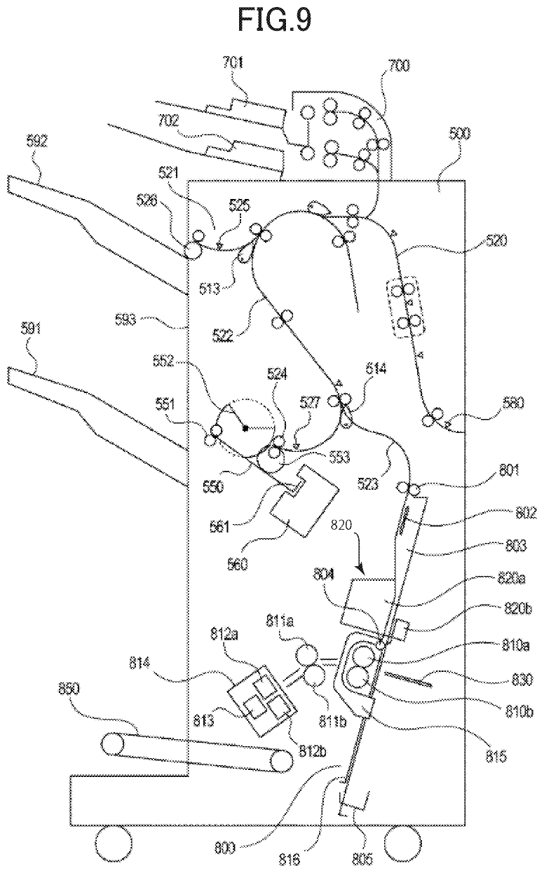

As illustrated in FIG. 9, the finisher 100 includes a conveyance path 520 through which the sheet conveyed via the perforating apparatus 200 is taken into the apparatus, and a plurality of conveyance roller pairs are disposed along the conveyance path 520.

A switching member 513 disposed at a terminal end of the conveyance path 520 switches paths between an upper sheet discharge path 521 and a lower sheet discharge path 522 that are connected downstream thereof. The upper sheet discharge path 521 discharges sheets onto an upper stack tray 592. Meanwhile, the lower sheet discharge path 522 discharges sheets onto a processing tray 550. The sheets discharged onto the processing tray 550 are subjected to a conveyance direction alignment in which the trailing edge of the sheets are abutted against a trailing edge reference wall 561 by a pull-back paddle 552 and a return belt 553 and a width direction alignment using an aligning plate not shown sequentially, by which the sheets are stored in a bundle. Thereafter, the sheets being stored in a bundle, i.e., sheet bundle, are subjected to a sorting process, a stapling process and the like according to the setting entered through the operation screen 601 and thereafter, the sheet bundle is discharged by a bundle sheet discharge roller pair 551 onto stack trays 591 and 592.

The stapling process described above is performed by a stapler 560, and the stapler 560 is movable in a width direction orthogonal to the conveyance direction to staple an arbitrary position of the sheets. The stack trays 591 and 592 are movable in an up-down direction, wherein the stack tray 592 on an upper side can receive sheets from the upper sheet discharge path 521 and the processing tray 550, and the stack tray 591 on a lower side can receive sheets from the processing tray 550. As described, a large amount of sheets can be stacked on the stack trays 591 and 592, and the trailing edges of the stacked sheets are regulated and aligned by a trailing edge guide 593 that extends in the up-down direction.

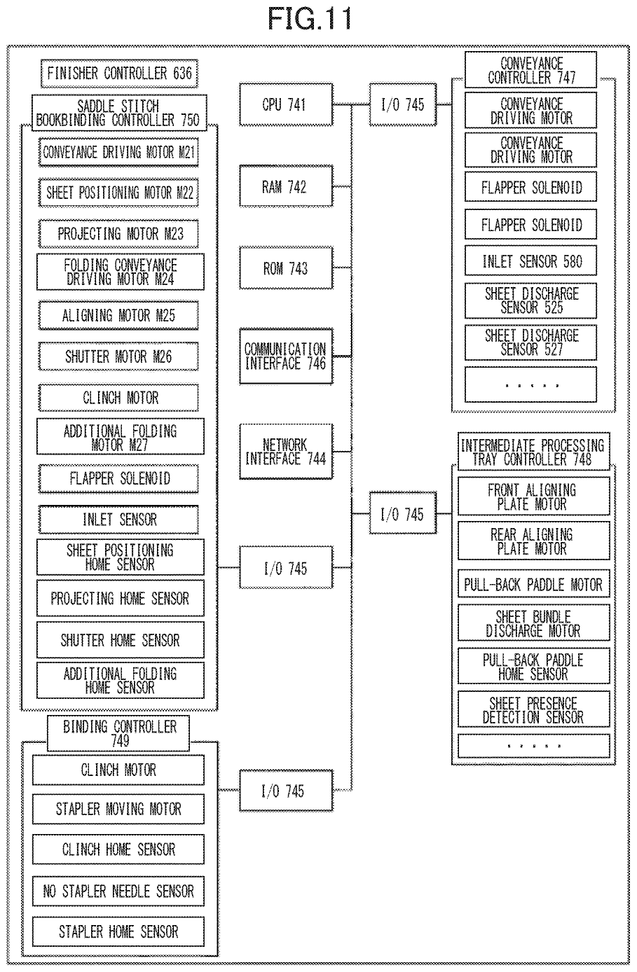

Next, a configuration of a saddle stitch bookbinding portion 800 that functions as a bookbinding processing portion, a bookbinding processing devise, or a bookbinding processing mechanism is described. The sheet having its conveyance path switched to a right side path by a switching member 514 disposed in midway of the lower sheet discharge path 522 is passed through a saddle sheet discharge path 523 and sent to the saddle stitch bookbinding portion 800. The sheet is delivered to a saddle inlet roller pair 801, and a delivery inlet of the sheet is selected by a switching member 802 that is operated by a solenoid according to sheet size, and the sheet is conveyed into a storage guide 803 of the saddle stitch bookbinding portion 800. The delivered sheet is conveyed by a slip roller 804 until the leading edge of the sheet comes into contact with a movable sheet positioning member 805. The saddle inlet roller pair 801 and the slip roller 804 are driven by a motor M21 (refer to FIG. 11). Further, a stapler 820 is disposed in midway of the storage guide 803 at a position facing and interposing the storage guide 803. The stapler 820 functions as a saddle stitching portion, a saddle stitching devise or a saddle stitching mechanism that performs a stitching process to the sheet bundle composed of a plurality of sheets. The stapler 820 is separated into a driver 820a for projecting stapler needles and an anvil 820b for bending the projected needles. In a case where there is a page on which linear perforation is formed included in a booklet being subjected to bookbinding, the plurality of sheets constituting the sheet bundle includes a sheet on which linear perforation is formed by the perforating apparatus 200. Further, during delivery of sheets, the sheet positioning member 805 stops at a position where an intermediate position of the sheet in the longitudinal direction is set at a stapling position of the stapler. The sheet positioning member 805 is movable by receiving drive from a motor M22 (refer to FIG. 11), and the position of the sheet positioning member 805 is changed according to the sheet size.

A folding roller pair 810a and 810b that constitutes a folding portion is disposed downstream of the stapler 820 disposed such that a driver 820a and an anvil 820b face each other interposing the storage guide 803, and a projecting member 830 is disposed at a position facing the folding roller pair 810a and 810b. The projecting member 830 sets a position retracted from the storage guide 803 as a home position. The projecting member 830 is projected toward the accommodated sheet bundle by the drive of a motor M23 (refer to FIG. 11), by which the sheet bundle is pushed into a nip between the folding roller pair 810a and 810b and the sheet bundle is folded. Thereafter, the projecting member 830 is returned to the home position. A pressure F1 sufficient to fold the sheet bundle is applied between the folding roller pair 810a and 810b by a spring not shown. The folding roller pair 810a and 810b and the projecting member 830 constitute a folding portion that performs a folding process to fold the sheet bundle in half. It is noted that the folding portion can be referred to as a folding devise or a folding mechanism.

The folded sheet bundle is discharged via a first folded sheet bundle conveyance roller pair 811a and 811b, and a second folded sheet bundle conveyance roller pair 812a and 812b constituting a square back processing portion 814 onto a folded sheet bundle discharge tray 850. Pressures F2 and F3 that are sufficient to convey and stop the folded sheet bundle are applied to the first folded sheet bundle conveyance roller pair 811a and 811b and the second folded sheet bundle conveyance roller pair, i.e., pressure roller pair, 812a and 812b. A shutter 816 moves in a direction parallel to the storage guide 803 to a position where the leading edge of the sheet is not in contact with the folding roller pair 810a and 810b in a state where the sheet is delivered to the storage guide 803, and to a position where a path toward the folding roller pair 810a and 810b is opened in a state where the projecting member 830 is projected toward the sheet bundle. This movement operation is performed by a drive of a motor M26 (refer to FIG. 11).

The folding roller pair 810a and 810b, the first folded sheet bundle conveyance roller pair 811a and 811b, and the second folded sheet bundle conveyance roller pair 812a and 812b are rotated at a constant speed by a same motor M24 (refer to FIG. 11).

Further, in order to fold the sheet bundle stapled by the stapler 820 disposed to face and interpose the storage guide 803, the sheet positioning member 805 is lowered for a predetermined length from the position of the sheet positioning member 805 when the stapling process is performed, such that the stapled position of the sheet bundle is moved to a nip position of the folding roller pair 810a and 810b after the stapling process is ended. Thereby, the sheet bundle can be folded such that the position where the stapling process has been performed is set as the crease, i.e., the intermediate position in the longitudinal direction.

An aligning plate pair 815 is an aligning plate pair having a surface that protrudes toward the storage guide 803 while being disposed to go round the outer circumference surfaces of the folding roller pair 810a and 810b, and that aligns the sheets accommodated in the storage guide 803. The aligning plate pair 815 aligns the sheet in the width direction by moving toward a folding direction of the sheet by receiving the drive of a motor M25 (refer to FIG. 11).

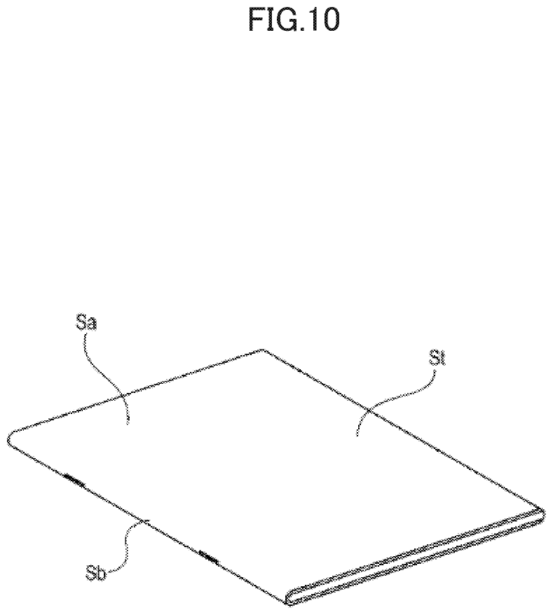

According to the saddle stitch bookbinding portion 800 configured as described above, a booklet St, which is a sheet bundle whose intermediate position in the longitudinal direction of the sheet, i.e., crease, is subjected to saddle stitch binding process and which is folded in half at the saddle stitched position, is created, as illustrated in FIG. 10.

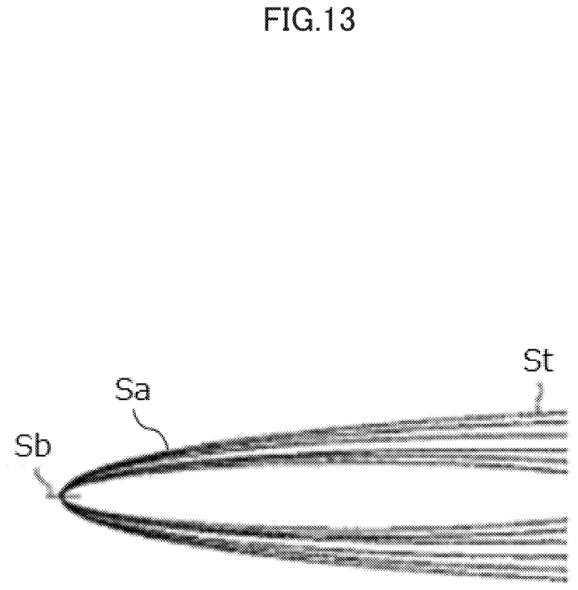

If the sheet bundle is thick and the folding of the sheet bundle becomes loose, the created booklet St will be a booklet whose folded portion Sa is bulged, as illustrated in FIG. 13. In contrast, if the sheet bundle is thin and can be folded tightly, the created booklet may have a crack formed at the folded portion, i.e., spine, Sb. Specifically, the crack is notable if the sheet used for the front cover is a thick paper. A creasing portion may be used to perform creasing to the folded portion so as to reduce cracking. It is noted that the creasing portion can be referred to as a creasing devise, or a creasing mechanism.

According to the embodiment of the bookbinding processing portion described above, a saddle stitch binding in which a binding process of performing saddle stitch binding to a sheet bundle was described, but the position of the saddle stitch binding can be somewhat displaced from a center of the sheet. Further, as for a folding process in which the sheet bundle is folded in half, the half fold position can be somewhat displaced from the center of the sheet, and can be set within a range in which the user recognizes the sheet bundle as a booklet. Further, the folding position and the binding position preferably coincides, but they can be somewhat displaced.

Next, the square back processing portion 814 that functions as a square back processing portion will be described. The square back processing portion 814 is disposed downstream in the sheet conveyance direction of the folding roller pair 810a and 810b and the projecting member 830 that constitute the folding portion, and stops a leading edge side, i.e., spine portion, of the half-folded sheet bundle at a predetermined position of the sheet bundle to subject the spine portion to the square back processing. According to the present embodiment, the square back processing portion 814 is assembled into the finisher 100 as a portion of the saddle stitch bookbinding portion 800, but alternatively, it may be disposed as an independent apparatus arranged downstream of the saddle stitch bookbinding portion.

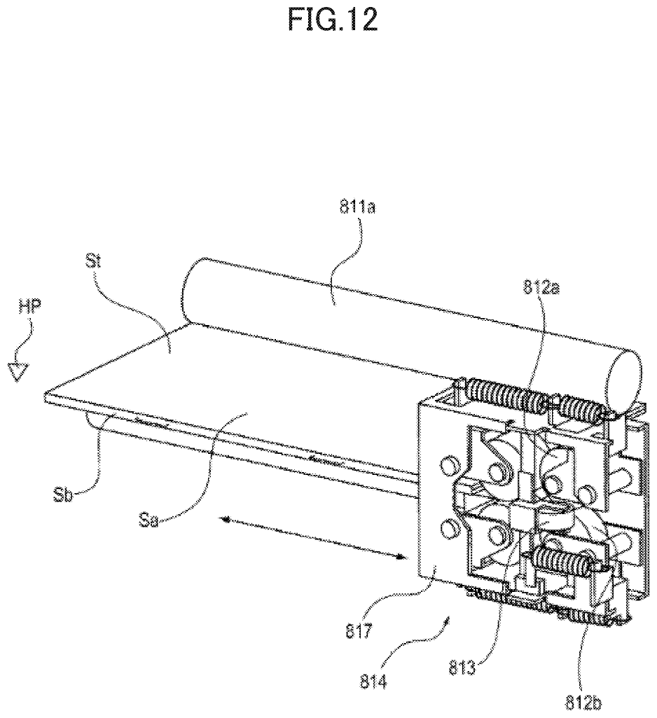

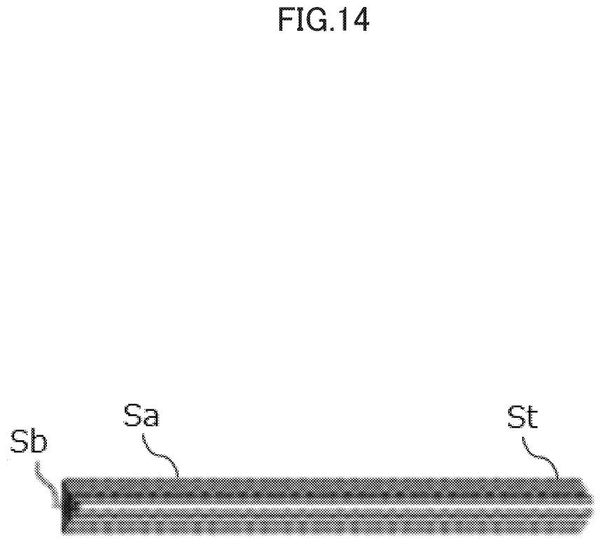

FIG. 12 is a perspective view of the square back processing portion 814. The square back processing portion 814 includes the second folded sheet bundle conveyance roller pair, i.e., pressure roller pair, 812a and 812b that nips and presses the booklet St from a thickness direction of the booklet, a back pressing roller 813 that presses the spine of the booklet from a direction orthogonal to the thickness, and a frame 817 having the second folded sheet bundle conveyance roller pair, i.e., pressure roller pair, 812a and 812b and the back pressing roller 813 assembled thereto. The frame 817 is supported movably on a guide portion not shown that guides the frame 817 movably in parallel with the spine of the booklet, and is driven by a drive portion not shown. Along with the movement of the square back processing portion 814, the folded portion of the booklet is pressed by the second folded sheet bundle conveyance roller pair, i.e., pressure roller pair, 812a and 812b while being flattened by the back pressing roller 813, by which a booklet having a spine that is flat and not bulged as illustrated in FIG. 14 may be created. It is noted that in the following explanation, the flattened spine will be referred to as a square back, but it can also be referred to as a square spine. Also, the square back processing of forming the square back can be referred to as a square spine processing or a square fold processing.

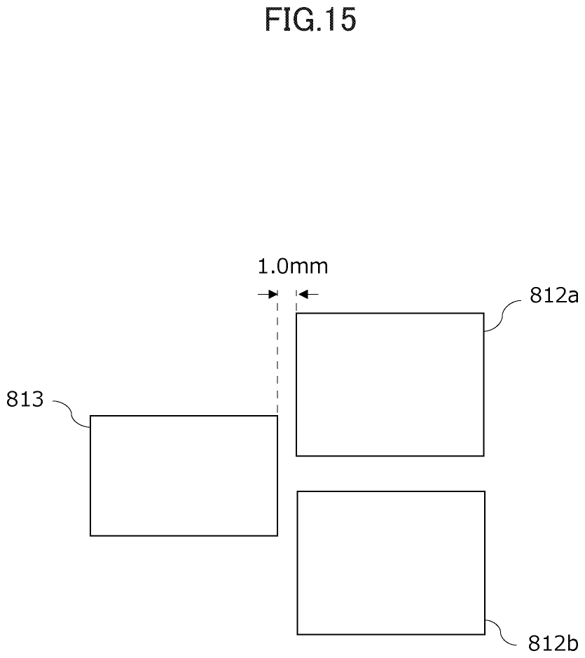

FIG. 15 is a cross-sectional view of the square back processing portion 814 viewed from a side. As described above, the pressure required for the square back processing of processing the shape of the fold of the spine portion of the half-folded sheet bundle into a flat shape depends on a grammage of the sheet or the number of sheets constituting the half-folded sheet bundle, and in the present embodiment, the pressure is determined based on a stop position of the half-folded sheet bundle when executing the square back processing, more specifically, the distance of protrusion of a leading edge side, i.e., spine portion, of the half-folded sheet bundle from the second folded sheet bundle conveyance roller pair 812a and 812b in the stop position of the half-folded sheet bundle. In the present embodiment, as illustrated in FIG. 15, a configuration is adopted where a distance from an end portion of the second folded sheet bundle conveyance roller pair 812a and 812b to an end portion of the back pressing roller 813 is set to 1.0 mm.

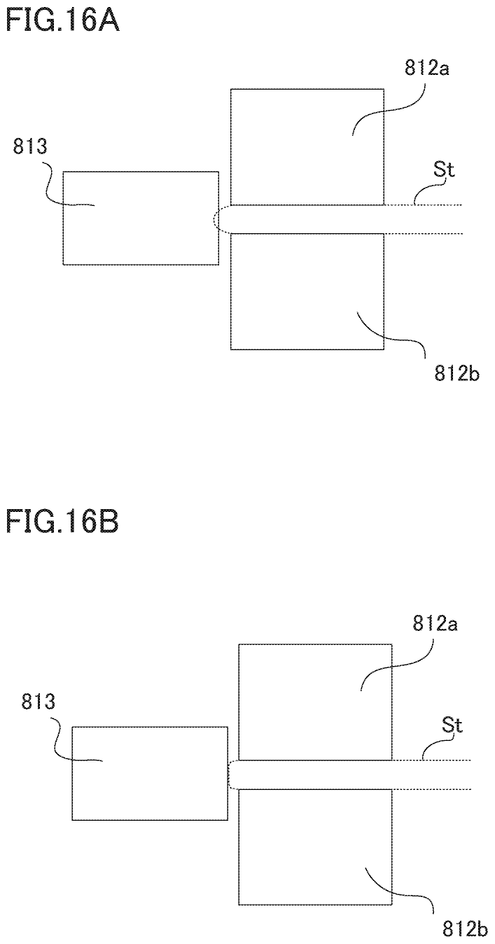

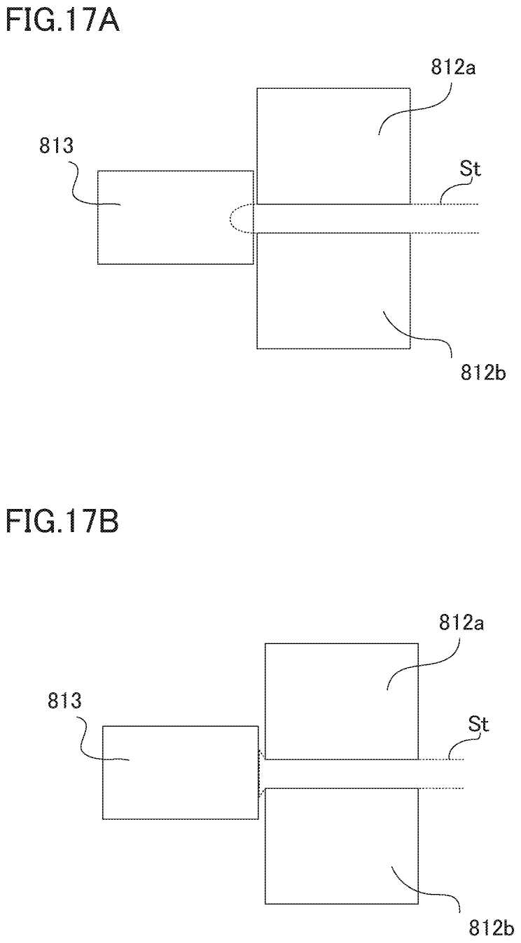

In the square back processing, as the number of sheets constituting the half-folded sheet bundle increases, and as the grammage of the sheet increases, a stronger pressure becomes necessary. For example, FIGS. 16A and 16B illustrate a stop position of a case where the square back processing is performed to a half-folded sheet bundle composed of five sheets, each sheet having a grammage of 52 gsm, and in the present embodiment, the sheet bundle is stopped at a position where the leading edge side, i.e., spine portion, of the half-folded sheet bundle is protruded by 1.49 mm from the second folded sheet bundle conveyance roller pair 812a and 812b. That is, in this case, the spine portion of the half-folded sheet bundle is pressed, i.e., flattened, by (1.49−1.0)=0.49 mm by the square back processing. Further, FIGS. 17A and 17B illustrate a stop position of a case where the square back processing is performed to a half-folded sheet bundle composed of 30 sheets, each sheet having a grammage of 105 gsm, and in the present embodiment, the sheet bundle is stopped at a position where the leading edge side, i.e., spine portion, of the half-folded sheet bundle is protruded by 4.96 mm from the second folded sheet bundle conveyance roller pair 812a and 812b. That is, in this case, the spine portion of the half-folded sheet bundle is pressed, i.e., flattened, by (4.96−1.0)=3.96 mm by the square back processing. As described, if a stronger pressure is required, the pressure required for the square back processing is optimized by changing the stop position of the leading edge side, i.e., spine portion, of the half-folded sheet bundle, such as by increasing the amount of protrusion of the sheet bundle from the second folded sheet bundle conveyance roller pair 812a and 812b.

The square back processing described in the above embodiment is not limited to a certain system as long as the spine portion of the sheets can be squared, and as long as the spine portion is formed such that arbitrary opening of a half-folded booklet can be suppressed. For example, it may be possible to adopt a configuration including a clamping structure that clamps a back of a booklet in a protruded state from the pressure roller pair 812a and 812b illustrated in FIGS. 15 to 17B, and forming a square back shape by pressing the spine in the protruded state by the back pressing roller 813 that may be moved independently.

As illustrated in FIG. 11, the finisher controller 636 includes a microcomputer (CPU) 741, a RAM 742, a ROM 743, an input/output unit (I/O) 745, a communication interface 746, and a network interface 744. A conveyance processing is performed by the conveyance controller 747. In an intermediate processing tray controller 748, operation control of front/rear aligning plates of the processing tray 550, a rotation control of the pull-back paddle, and rotation control of the sheet bundle discharge roller are respectively controlled by a home position detection sensor and a drive motor. In a binding controller 749, a clinch of the stapler and the movement are controlled by a home position detection sensor and a moving motor. In a saddle stitch bookbinding controller 750, an operation control of an aligning plate, a rotation control of a folding conveyance roller, an operation control of a projecting member, an operation control for sheet positioning, an operation control of a stapler clinch, and an operation control of an additional folding portion are controlled by a home position detection sensor and a moving motor. Various sensor signals are entered to an input port of the I/O 745. The output port of the I/O 745 is connected to a control block not shown or to various drive systems connected via various drivers not shown.

However when a square back processing for flattening the shape of the fold of the spine portion of the half-folded sheet bundle which is subjected to a perforating processing performed near the spine portion, if the amount of pressing of the spine portion of the sheet bundle by the square back processing is not considered, there was a drawback that the perforation position of the half-folded sheet bundle, i.e., booklet subjected to the saddle stitch bookbinding processing, is displaced corresponding to the amount of pressing of the spine portion of the sheet bundle by the square back processing from the expected perforation position.

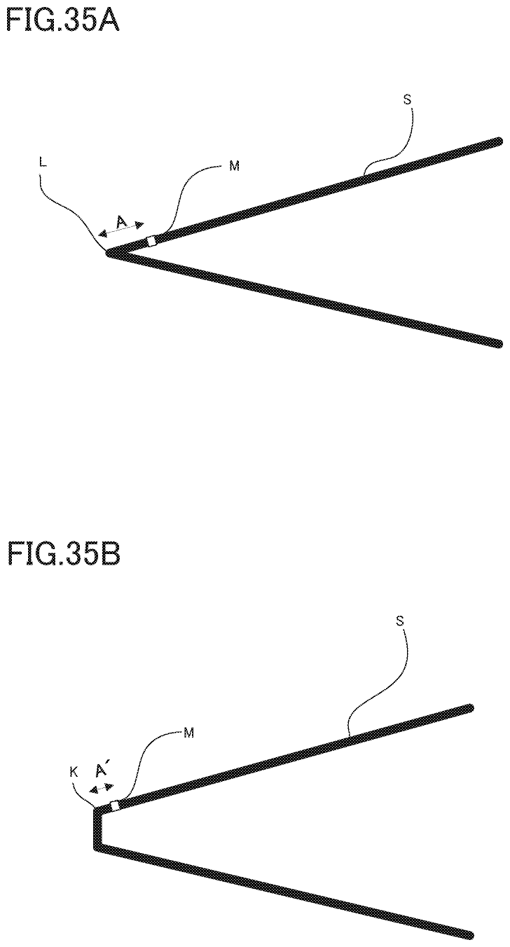

The state of occurrence of the drawback will be described with reference to FIGS. 35A and 35B. FIG. 35A is an explanatory view illustrating a state in which a perforating processing has been performed to a position M separated by a predetermined length A from a fold L that is created when the booklet St is subjected to a bookbinding processing. FIG. 35B is a view illustrating a state in which the booklet St is subjected to a bookbinding processing, and further subjected to a square back processing. In this state, if a perforating processing position M is set by setting the predetermined length A to have the same length, because an edge portion K of the square back portion serves as a starting point for opening the booklet, a distance to the perforating processing position becomes A′, which is shorter than A.

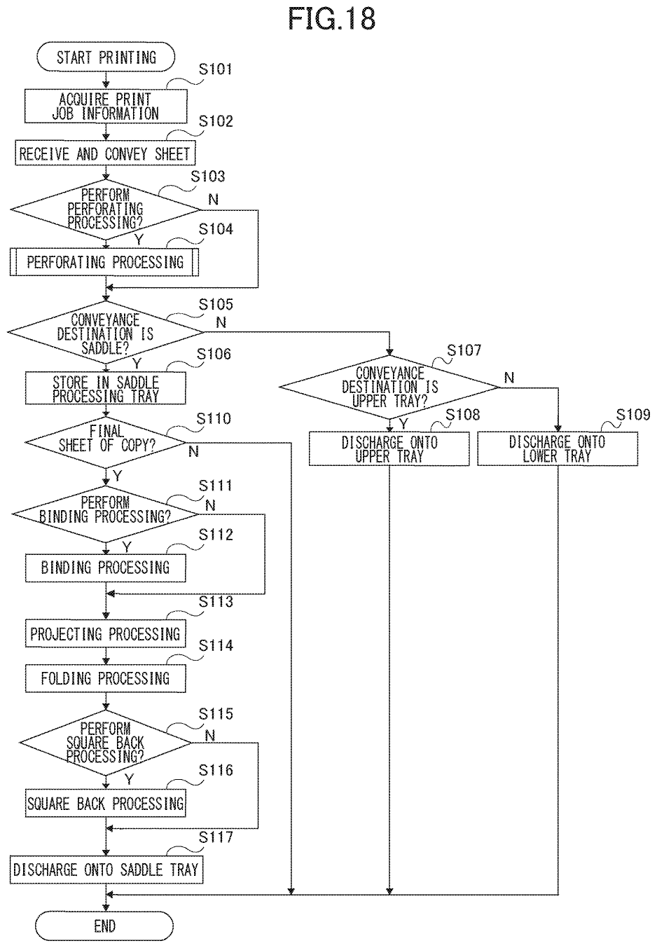

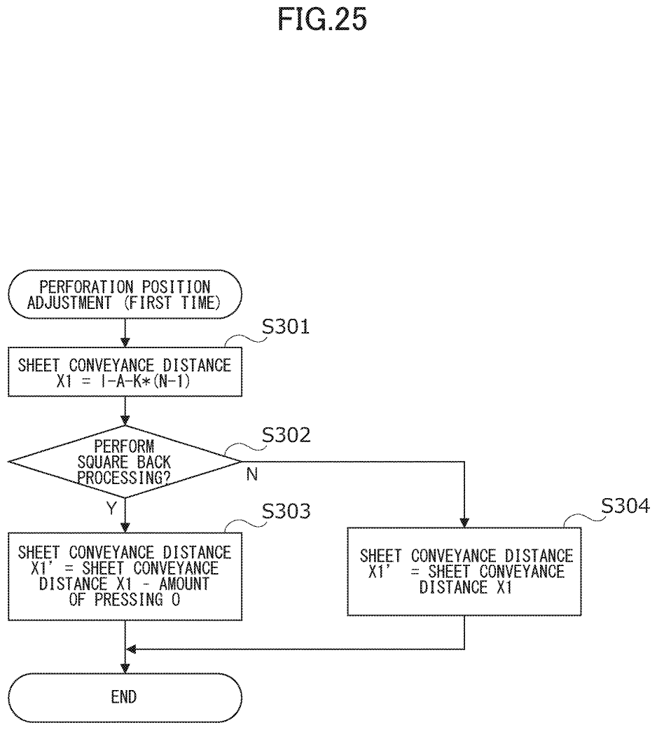

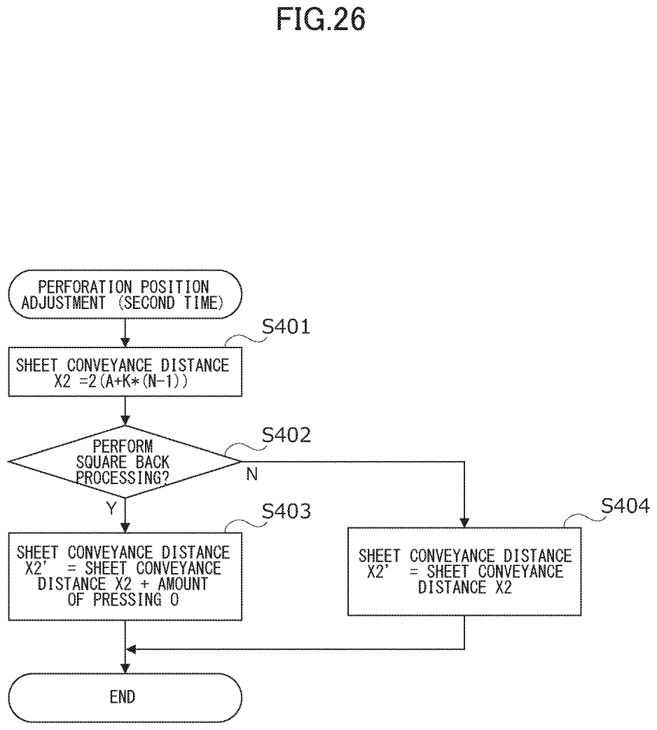

Therefore, according to the present disclosure, when performing the square back processing to a half-folded sheet bundle, the problem described above is solved by carrying out, to one sheet of the plurality of sheets constituting the sheet bundle, a correction corresponding to a pressed amount of the spine portion of the sheet bundle by the square back processing in a state where a plurality of perforating processing are performed to approximately symmetric positions of the sheet with respect to an intermediate position of the sheet in the longitudinal direction. FIGS. 18, 19, 25, and 26 are each a flowchart illustrating the present disclosure. Unless denoted otherwise, the following operations are executed by the CPU 701 disposed in the perforating apparatus controller 638, hereinafter referred to as the CPU 701, or the CPU 741 disposed in the finisher controller 636, hereinafter referred to as the CPU 741.

When a printing process is executed, the CPU 701 and the CPU 741 acquire a print job information notified from the CPU circuit portion 630 of the image forming apparatus controller (S101).

Sequentially, when a sheet is discharged from the image forming apparatus 600 to the perforating apparatus 200, the CPU 701 receives the sheet and conveys the sheet into the perforating apparatus 200 (S102).

The CPU 701 determines whether to perform a perforating processing to the conveyed sheet based on a job information acquired in S101 (S103). When it is determined that the perforating processing is not to be performed (S103: N), the procedure is advanced to S105, and when it is determined that the perforating processing is to be performed (S103: Y), the CPU 701 stops the sheet at a predetermined position in the perforation path B and performs the perforating processing to the stopped sheet by a perforating driving motor M1 in S104. The details of the perforating processing will be described below.

Thereafter, in S105, the CPU 701 and the CPU 741 determine whether the discharge destination of the sheet is a saddle tray 850. If it is determined that the discharge destination is not the saddle tray 850 (S105: N), it is determined further in S107 whether the discharge destination is the upper stack tray 592. If it is determined that the discharge destination is the upper stack tray 592 (S107: Y), the CPU 701 and the CPU 741 reconvey the stopped sheet, discharge the sheet onto the upper stack tray 592 (S108), and end the processing. Further, if it is determined in S107 that the discharge destination is the lower stack tray 591 (S107: N), the CPU 701 and the CPU 741 reconvey the stopped sheet, discharge the sheet onto the lower stack tray 591 (S109), and end the processing.

Meanwhile, if it is determined in S105 that the discharge destination of the sheet is the saddle tray 850 (S105: Y), the stopped sheet is reconveyed to be stacked onto a saddle processing tray (S106) to form a sheet bundle, and the CPU 741 further determines in S110 whether the stacked sheet is a final sheet of a copy.

If it is determined in S110 that the stacked sheet is not a final sheet of a copy (S110: N), the processing is ended, and if it is determined that the sheet is a final sheet of a copy (S110: Y), whether to perform a binding process to the formed sheet bundle is subsequently determined (S111).

If it is determined in S111 that the binding process is to be performed (S111: Y), the CPU 741 executes the binding process to the sheet bundle using a stapler (S112), and the procedure is advanced to S113. Meanwhile, if it is determined in S111 that the binding process is not to be performed (S111: N), the CPU 701 advances the procedure to S113 without executing the binding process to the sheet bundle.

Thereafter, the CPU 741 executes a projecting process in S113 and a folding process in S114 to the sheet bundle, and forms a half-folded sheet bundle.

Next, the CPU 741 determines whether to perform a square back processing to the half-folded sheet bundle based on the job information acquired in S101 (S115). If it is determined that square back processing is not to be performed to the half-folded sheet bundle (S115: N), the CPU 741 discharges the half-folded sheet bundle to the saddle tray 850 in S117 without performing the square back processing, and ends the processing. Meanwhile, if it is determined that the square back processing is to be performed (S115: Y), the CPU 741 performs the square back processing in S116, and thereafter, discharges the half-folded sheet bundle to the saddle tray 850 in S117, and ends the processing.

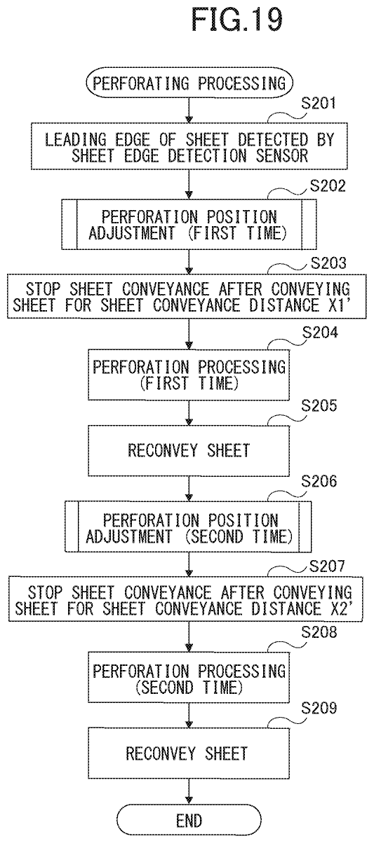

Next, a perforating processing such as the linear perforation processing or the punched hole perforation processing according to the present disclosure will be described with reference to the flowcharts of FIGS. 19, 25, and 26.

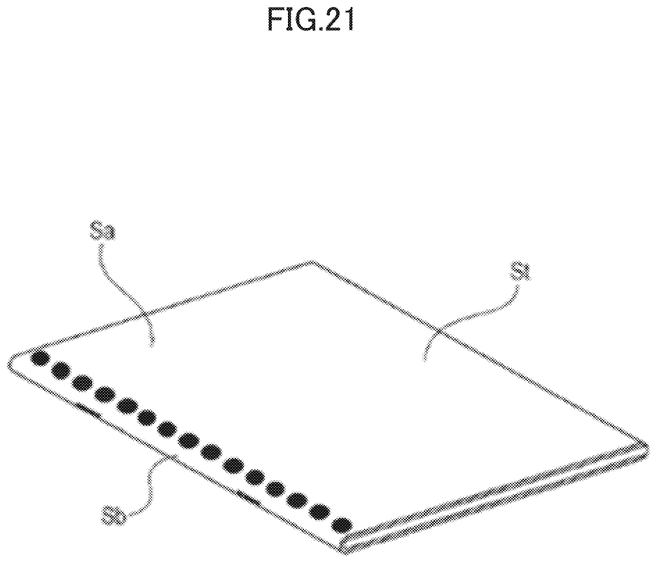

In the case of booklets and catalogues having a large number of pages, a high-quality product subjected to the square back processing as described above is required, and even in the case of such a product, it is preferable to enable a linear perforation to be provided on pages such that tickets and cards can be created by allowing the user to cut the paper at a position intended by the user, or to enable punched holes for ring binders to be provided on the sheets such that the sheets can be filed at a position intended by the user (refer for example to FIG. 21).

Further, as a similar process, a creasing process, i.e., creasing, is known that allows the page to be folded at a position intended by the user.

The linear perforation processing is a processing that allows the user holding the product to cut a sheet thereof easily by hand. Therefore, it is necessary to leave an intended length to remain on the product such that when cutting the sheet along the linear perforation, the user can hold the remaining portion, i.e., spine side of the booklet, by his/her hand. Further, in the punched hole perforation process, if the positional displacement becomes too large, it may not be possible to file the product. In the creasing process, the quality of the product may be deteriorated, such as having a page turned at a position that differs from the intended position.

According to the perforating processing of the present disclosure, at first, when the CPU 701 detects a leading edge of the sheet by the sheet edge detection sensor 213 (S201), a perforation position adjustment (first time) is performed in S202, and a sheet conveyance distance X1′ (stop position) from the sheet edge detection sensor 213 for executing the perforating processing (first time) is calculated.

In the perforation position adjustment (first time), at first in S301, the CPU 701 calculates a sheet conveyance distance X1 after the leading edge of the sheet has been detected by the sheet edge detection sensor 213, similar to the conventional technique. The conveyance amount X1 before the perforating processing (first time) in this state may be expressed by X1=(l−A−0.1*(N−1)) as described above, when the sheet S is the Nth sheet. For example, in a case where the sheet is a thick paper instead of a normal paper, control corresponding to the sheet thickness is enabled by setting the coefficient K of (N−1) of the above equation to approximately 0.2 instead of 0.1.

Thereafter, in S302, the CPU 701 determines whether to perform the square back processing to the half-folded sheet bundle. If it is determined that the square back processing is not to be performed (S302: N), the sheet conveyance distance X1′ (stop position) from the sheet edge detection sensor 213 for carrying out the perforating processing (first time) is not subjected to a correction process, and the sheet conveyance distance X1 calculated based on the above equation is determined as it is as the final sheet conveyance distance X1′ (stop position) (S304).

Meanwhile, if it is determined in S302 that the square back processing is to be performed (S302: Y), the CPU 701 performs correction corresponding to a length, i.e., pressed amount O, of the spine portion of the half-folded sheet bundle that has been pressed by the square back processing from the job information acquired in S101, and determines the sheet conveyance distance X1′ (stop position) from the sheet edge detection sensor 213 for performing the perforating processing (first time). In this state, the sheet conveyance distance X1′ is expressed by X1′=X1−pressed amount O. Further, as described above, the pressed amount O is 0.49 mm in a case where the square back processing is performed to a half-folded sheet bundle composed of five sheets, each sheet having a grammage of 52 gsm, and is 3.96 mm in a case where the square back processing is performed to a half-folded sheet bundle composed of 30 sheets, each sheet having a grammage of 105 gsm, wherein in the present embodiment, the sheet conveyance distance X1′ is corrected by the value of the pressed amount O described above.

When the sheet conveyance distance X1′ is determined in S202, the CPU 701 stops the sheet after conveying the sheet for a distance corresponding to the sheet conveyance distance X1′ in S203, and performs a perforating processing (first time) to the stopped sheet in S204.

When the perforating processing (first time) is performed to the sheet in S204, the CPU 701 starts reconveyance of the sheet in S205, and thereafter, calculates a sheet conveyance distance X2′ (stop position) for performing the perforating processing (second time) in S206.

In perforation position adjustment (second time), at first, in S401, the CPU 701 calculates a sheet conveyance distance X2 after having performed the perforating processing (first time) similar to the conventional technique. A conveyance amount X2 before the perforating processing (second time) in this state can be expressed by X2=2(A+0.1*(N−1)), when the sheet S is the Nth sheet, as described above. In a case where the sheet S is a thick paper instead of a normal paper, control corresponding to the sheet thickness is enabled by setting a coefficient of (N- 1) of the above equation to approximately 0.2 instead of 0.1.

Next, the CPU 701 determines whether to perform the square back processing to the half-folded sheet bundle in S402. If it is determined that the square back processing is not to be performed (S402: N), the sheet conveyance distance X2′ (stop position) for performing the perforating processing (second time) is not subjected to a correction process, and the sheet conveyance distance X2 calculated in the above-described process is determined as it is as the final sheet conveyance distance X2′ (stop position) (S404).

Meanwhile, if it is determined that the square back processing is to be performed in S402 (S402: Y), the CPU 701 performs correction corresponding to a length, i.e., pressed amount O, of the spine portion of the half-folded sheet bundle pressed by the square back processing from the job information acquired in S101, and determines the sheet conveyance distance X2′ (stop position) for performing the perforating processing (second time). The sheet conveyance distance X2′ in this state is expressed by X2′=X2+pressed amount O. Further, as described above, the pressed amount O is 0.49 mm in a case where the square back processing is performed to a half-folded sheet bundle composed of five sheets, each sheet having a grammage of 52 gsm, and is 3.96 mm in a case where the square back processing is performed to a half-folded sheet bundle composed of 30 sheets, each sheet having a grammage of 105 gsm, wherein in the present embodiment, the sheet conveyance distance X2′ is corrected by a value corresponding to the pressed amount O described above.

If the sheet conveyance distance X2′ is determined in S206, the CPU 701 stops the sheet after conveying the sheet for a distance corresponding to the sheet conveyance distance X2′ in S207, and performs the perforating processing (second time) to the stopped sheet in S208. Then, the sheet is reconveyed in S209, and the perforating processing is ended.

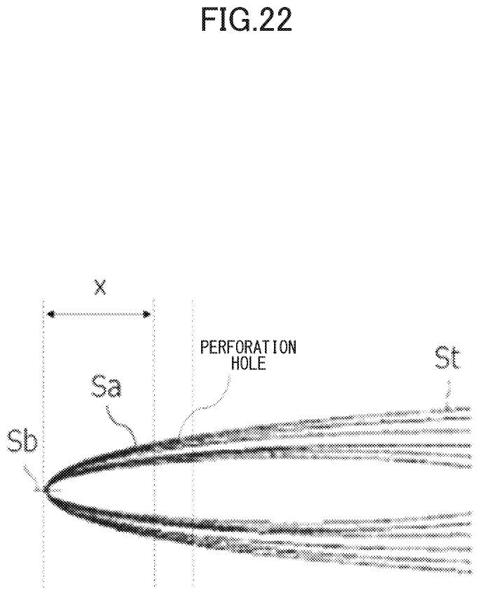

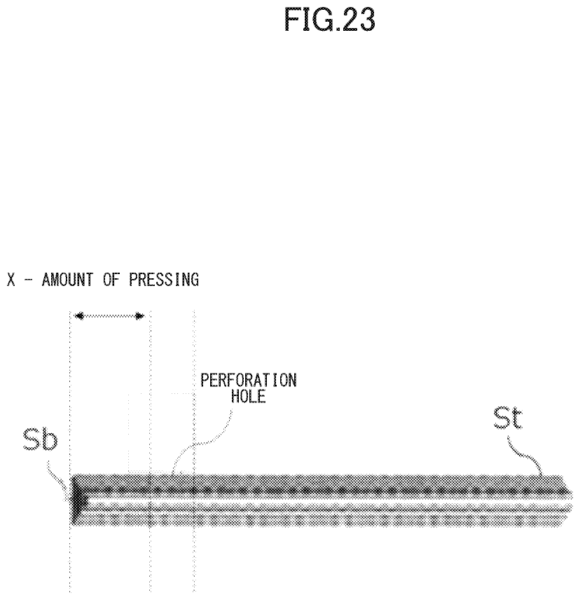

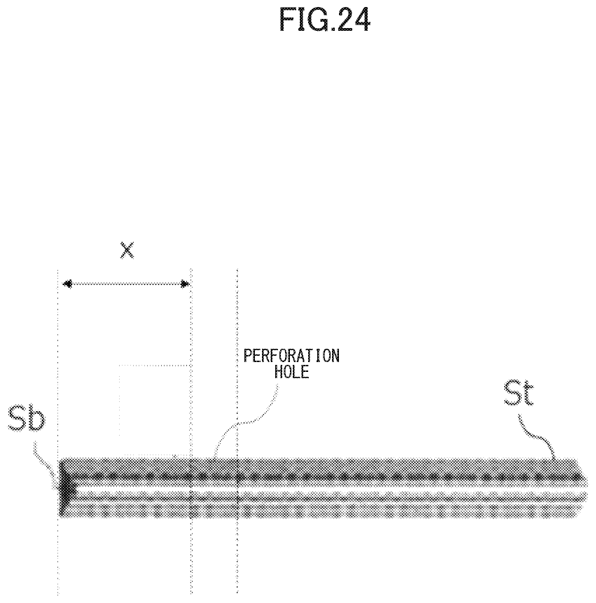

As described above, according to the present disclosure, when performing the square back processing to a half-folded sheet bundle, as illustrated in FIGS. 21 to 24, a drawback that the perforation position of the half-folded sheet bundle, i.e., booklet subjected to saddle stitch bookbinding processing, is displaced can be prevented by carrying out a correction corresponding to a pressed amount of the spine portion of the sheet bundle by the square back processing in a state where a plurality of perforating processing are performed to approximately symmetric positions of the sheet with respect to an intermediate position of the sheet in the longitudinal direction.

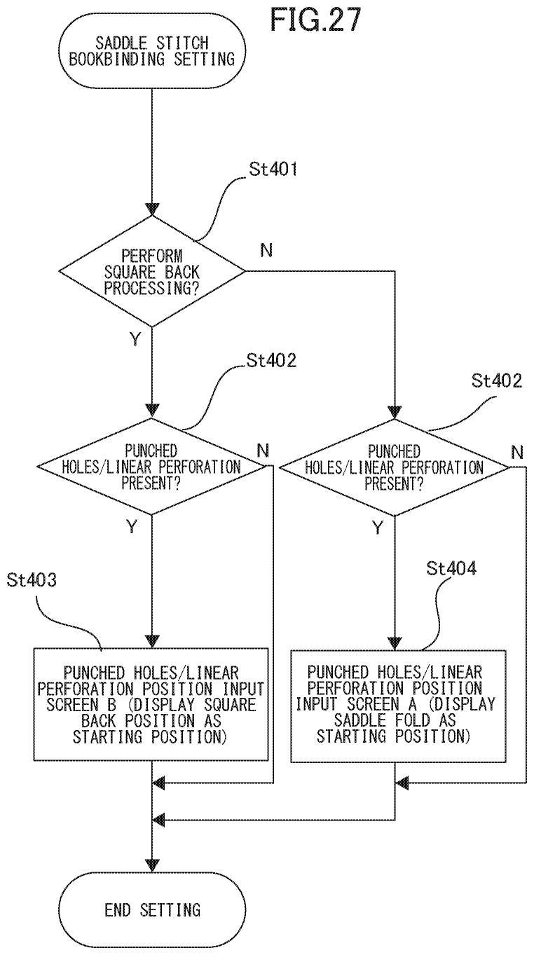

An even more preferable embodiment regarding the setting of the perforating processing position in a case where the square back processing is performed will be described in detail. The embodiment is described with reference to the flowchart of FIG. 27. FIG. 27 illustrates an order in which a saddle stitch bookbinding setting is displayed on an operation screen, i.e., screen display flow, including the square back processing and the perforating processing.

When the user sets that a saddle stitching bookbinding processing, a so-called saddle stitching process, is to be executed, the user subsequently selects whether to execute a square back processing (St401).

Next, the user sets whether to perform a perforating processing such as the punched hole perforation processing or the linear perforation processing described above (St402). The linear perforation processing according to the present embodiment refers to a cutting process performed intermittently from one edge to the other edge of the sheet to allow the sheet to be cut easily, and spaces between the cutting process or the lengths of the cutting process may be uneven. Further, instead of the cutting process, a fine punching process may also achieve the object of allowing the sheet to be cut easily, such that these processes are also included in the linear perforation processing.

Next, a perforation position input screen for entering a perforation position is displayed on the operation screen, wherein the perforation position input screen differs between a case where the square back processing is executed (St403) and a case where the square back processing is not executed (St404).

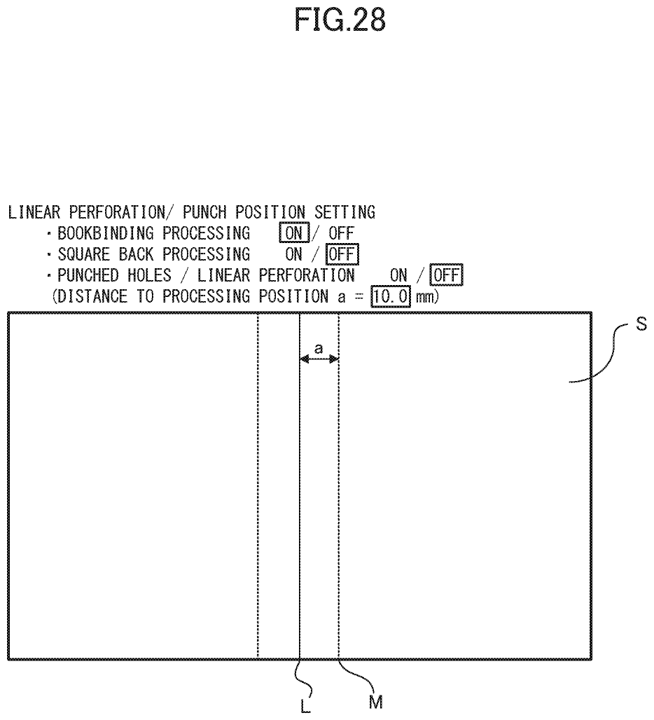

At first, the display on the operation screen in a case where the square back processing is not executed illustrated in FIG. 28 will be described. In a case where the square back processing is not performed, the perforation position is set such that a half fold line L is set as a base position, and the user enters a perforation position set as a certain distance in millimeters from the base position. The present embodiment illustrates a case where a position a at which the punch hole or a perforation M is set to be formed is 10 mm, and on the operation screen, a display, e.g., message, allowing the user to recognize that the length from the half folding line to the perforation is to be set is displayed.

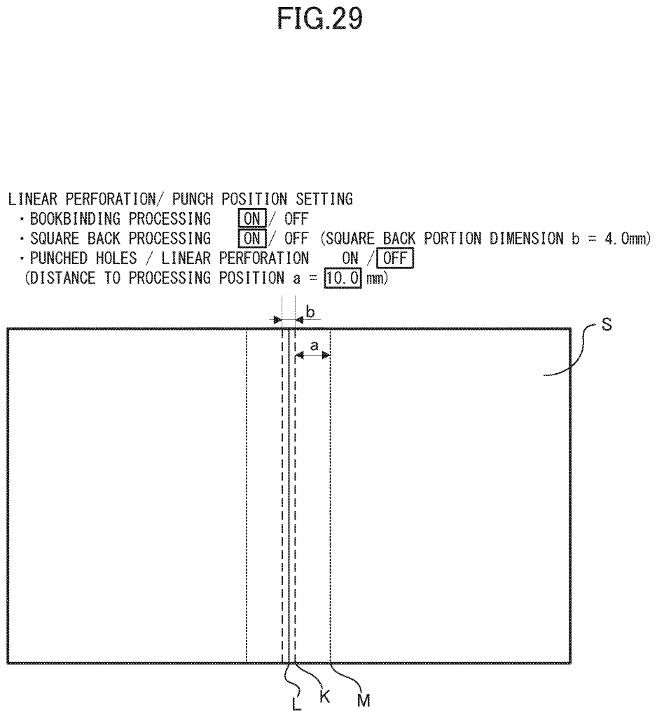

Next, the display on the operation screen in a case where the square back processing is to be executed illustrated in FIG. 29 will be described. In a case where both the square back processing and the perforating processing such as the linear perforation are to be performed, if the input screen for entering the position from the folding position during the bookbinding processing to the perforating processing for linear perforation as illustrated in FIG. 28 remains displayed on the screen, the operator will be confused regarding whether it is necessary to set the position of the linear perforation considering the dimension of the square back portion formed by the square back processing. Therefore, according to the present embodiment, in a case where both the square back processing and the perforating processing such as the linear perforation are to be performed, the display, e.g., message, on the screen is changed to prompt entry of a length “a” from the edge portion K to the processing position such as the linear perforation with the edge portion K of the square back portion set as a starting position.

The operation screen illustrated in FIG. 29 aims at enabling the operator to clearly recognize that the length that the operator is entering is the length from the edge of a spine portion created by the square back processing to the perforation position. Therefore, according to the operation screen illustrated in FIG. 29, an input unit for entering the dimension of the spine, i.e., square back portion, to be formed by the square back processing in millimeters, and an input unit for entering the distance from the edge of the spine portion formed by the square back processing to the processing position are displayed. In other words, a message to prompt entry of a length from the edge of the square back portion to a position where the linear perforation processing is to be performed is displayed on the operation screen. Further, according to the operation screen illustrated in FIG. 29, together with the input unit, a graphic (a drawing) illustrating a booklet, a graphic illustrating a square back portion, a graphic illustrating a linear perforation, and a graphic illustrating a range corresponding to a length from the edge of the square back portion to the position of the linear perforation are displayed. Further, the dimension of portion b of the spine can be displayed simply without displaying a specific dimension, such as indicating that X mm of square back portion is created uniformly, when performing a square back processing, or alternatively, an information table storing the dimensions of the square back portion according to the sheet type information, such as grammage of the sheet, and the number of sheets that form the sheet bundle can be provided in the ROM 631, and the dimension of the square back portion can be retrieved from the information table (ROM 631) based on the sheet type information, such as grammage of the sheet, and the number of sheets being set, and the specific dimension may be displayed. The length of the spine elongates as the grammage increases, and shortens as the grammage reduces. Further, the length of the spine tends to elongate as the number of sheets of the booklet increases. Even further, in the case of a processed sheet such as a coated paper or a synthetic paper formed of resin based on the sheet type information, the thickness increases similar to the case where the grammage is increased, and the length of the spine tends to elongate since the rigidity is increased.

The user can enter the length from the starting position to the perforation position, with the edge portion K of the square back portion drawn in FIG. 29 set as the starting position, such that it is possible to have the operator clearly recognize that the length to be entered by the operator is the length from the edge of the spine portion created by the square back processing to the perforation position. Thereby, it becomes possible to enable the setting of the perforating processing position, such the linear perforation, with the spine portion taken into consideration to be entered easily without any manual operation. Further, in a state where whether to perform the square back processing is changed in midway of setting of the perforating processing position, it is preferable to change the display screen each time, such that the operator can easily recognize that the dimension to be entered is changed due to the presence or absence of the square back processing.

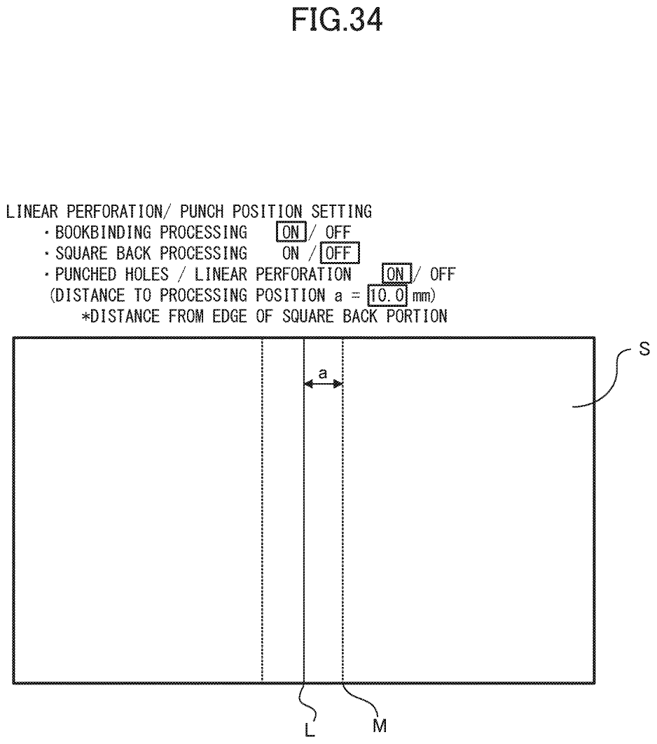

Various display methods may be adopted, as long as the function to have the operator recognize that the length to be entered by the operator is the length from the edge of the spine portion created by the square back processing to the perforation position. For example, when executing the square back processing, it may be effective to merely display “enter length from edge of square back to perforating processing position” by text information in the display for setting the perforating processing position (refer to FIG. 34). Further, for easier recognition, it is preferable to display a drawing of a booklet, and various display methods can be adopted such as displaying the position of the square back portion and the linear perforation processing on the sheet S, displaying the square back portion and erasing the display of a fold position formed by the fold portion on the drawing when execution of the square back processing is determined, displaying various settings using dotted lines, solid lines, and virtual lines (refer to FIG. 34), clearly indicating the position of the square back portion using different colors, and indicating the booklet in a folded state instead of the opened state (refer to FIG. 35B) to show the presence or absence of a square back portion and indicate that the length to be entered is the length from the square back portion.

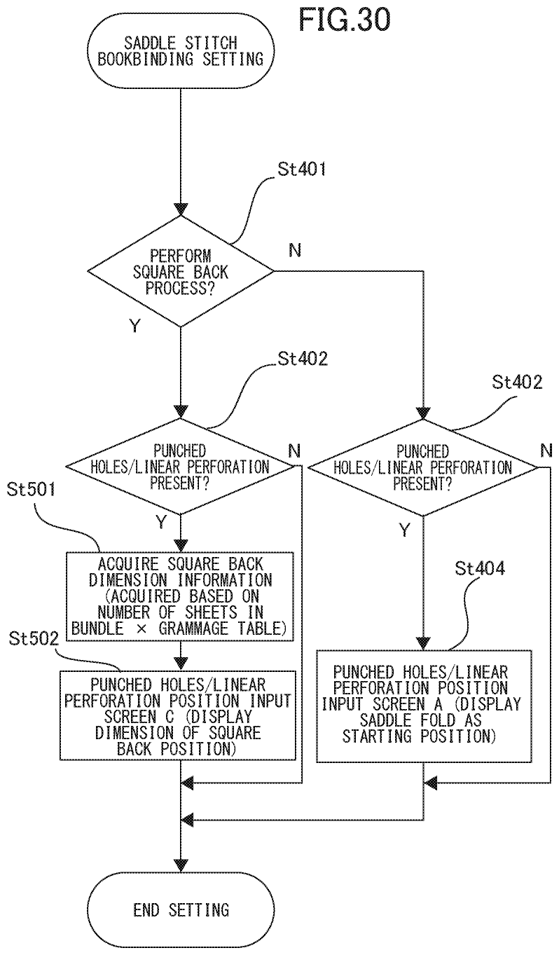

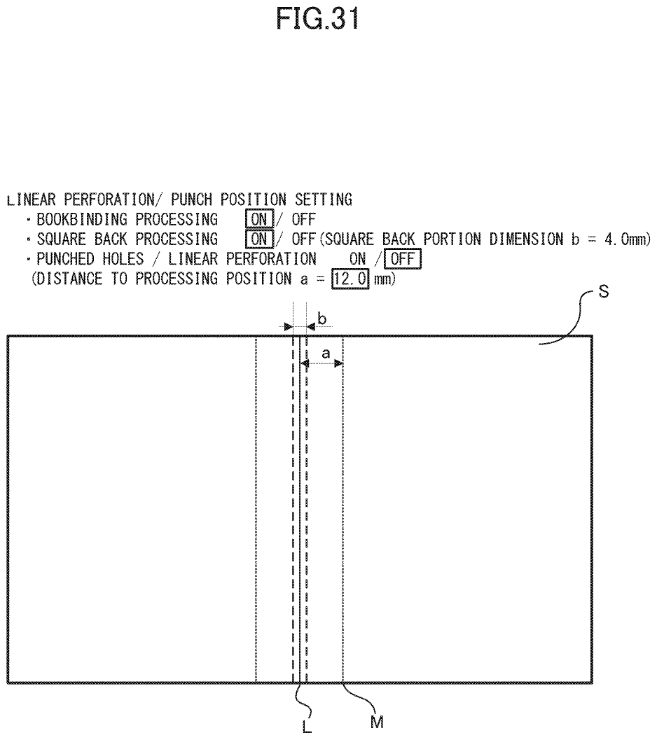

The flowchart of FIG. 30 and the drawing of FIG. 31 illustrate a different operation screen when executing the square back processing. On this screen, the dimension in millimeters of the spine created by the square back processing is illustrated, and the base position used for entering the perforation position is displayed as a half folding line L, similar to the case where the square back processing is not performed (St501). In this case, the user can set the length of the perforation position while recognizing a dimension b of the spine created by the square back processing. Since the display allows the user to visually recognize the effect of the dimension of the spine without changing the operation based on whether the square back processing is performed, the user can select the display format that he/she can easily recognize.

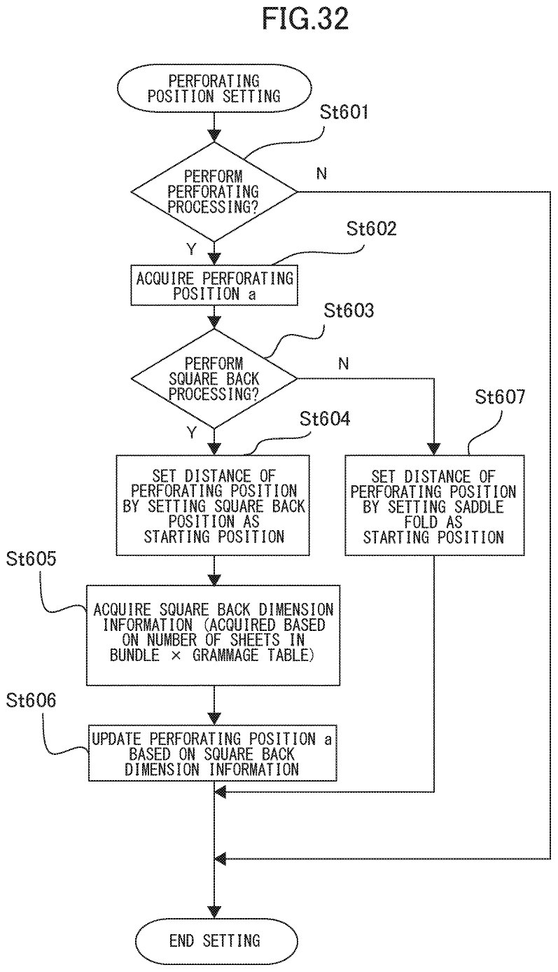

Another embodiment will be described based on the flowchart of FIG. 32. In this embodiment, regarding the sheet bundle to which a perforating processing is to be performed, the user simply enters the length from the fold of the booklet formed during the bookbinding processing to the perforating processing for forming a linear perforation and the like, regardless of whether the square back processing is to be performed, and the displacement of the perforating processing position of the linear perforation corresponding to the dimension of the square back portion caused by the square back processing is adjusted automatically by the system. According to the present embodiment, the display of length to the position to which the perforating processing such as the linear perforation is to be performed is displayed on a screen starting from a fold position according to a conventional bookbinding processing. If automatic adjustment of length corresponding to the square back processing is performed, it may be possible to display the same as text information. The present mode enables to provide a product having undergone a process such as linear perforation performed at the intended position, even if the operator does not recognize that a displacement of processing position of linear perforation has occurred by the square back processing.

When the user selects the saddle stitching process, a perforation position setting is started (St601). In a case where the perforating processing is determined to be performed, the user may enter a desirable perforating processing position (for example, at a position of 10 mm) on the operation screen of FIG. 28, and the perforation position information is acquired (St602). Next, whether the square back processing is to be performed is confirmed (St603), and if the square back processing is to be performed, the base position is changed to the square back position (St604), and a dimension of the spine is acquired from an information table (ROM 631) storing in advance the dimension of the spine in millimeters according to the grammage of the sheet and the number of sheets forming the sheet bundle provided in the CPU circuit portion 630 (St605). Next, ½ of the dimension information of the spine is added to the perforation position information and the information is updated (St606), and according thereto, the perforating processing is performed. Thereafter, the booklet having been subjected to the bookbinding processing and the square back processing is discharged to the exterior of the apparatus, and the user can acquire a product having a perforation position at a length of 10 mm from the intended position, that is, from the edge portion of the square back to the perforation position such as the linear perforation, without having to take into consideration the influence of the square back processing on the perforation position. That is, according to the present embodiment, the CPU circuit portion 630 adjusts the perforation position, such as the position of the linear perforation, in the perforating processing, such as the linear perforation processing, based on the execution instruction of the square back processing based on the square back processing portion.

For example, in a case where a mode in which a linear perforation processing is performed to the sheet positioned on the outermost side of the booklet and a square back processing is performed to the booklet subjected to the bookbinding processing is referred to as a first mode when a bookbinding processing is to be performed to a predetermined number of sheets of a predetermined type of sheet, and in a case where a mode in which a linear perforation processing is performed to the sheet positioned on the outermost side of the booklet and a square back processing is not performed to the booklet subjected to the bookbinding processing is referred to as a second mode when a bookbinding processing is to be performed to a predetermined number of sheets of a predetermined type of sheet, the CPU circuit portion 630 serving as an adjustment portion, an adjustment devise or an adjustment mechanism, adjusts the position of the linear perforation provided by the linear perforation unit such that the length from the fold position by the bookbinding processing of the sheet positioned on the outermost side of the booklet to the position of the linear perforation according to the first mode becomes longer than the length from the fold position by the bookbinding processing of the sheet positioned on the outermost side of the booklet to the position of the linear perforation according to the second mode. In other words, the adjustment portion is configured to adjust the position at which the linear perforation processing portion forms the linear perforation such that a length from a fold position where a plurality of sheets is folded in the bookbinding processing to a position at which a linear perforation is formed on an outermost sheet of a booklet formed using a first mode is longer than that of a booklet formed using a second mode, the first mode being a mode in which the linear perforation processing is performed on a sheet to be the outermost sheet of the booklet and the square back processing is performed on the booklet, the second mode being a mode in which the linear perforation processing is performed on a sheet to be the outermost sheet of the booklet and the square back processing is not performed on the booklet. The CPU circuit portion 630 adjusts the position of the perforation by controlling a perforating processing portion 200 similarly according to the perforating processing other than the linear perforation processing, such as a punching process. Furter, even in a case where a creasing process is to be performed, the CPU circuit portion 630 similarly controls the creasing processing portion 200 to adjust the position of the crease.

According to this embodiment, the user simply determines and sets the length from the edge of the sheet bundle, and the apparatus automatically computes the displacement caused by the dimension of the spine based on whether the square back processing is to be performed, such that the contents of the processing can be entered by a simple operation. The dimension of the square back portion elongates as the grammage increases, such that the length to the perforating processing position must also be elongated. The dimension of the square back portion shortens as the grammage decreases, such that the length to the perforating processing position must be shortened. Further, the dimension of the square back portion elongates as the number of sheets of the booklet increases, such that the length to the perforating processing position must be elongated. The dimension of the square back portion shortens as the number of sheets of the booklet reduces, such that the length to the perforating processing position must be shortened. Even if the length from the square back portion to the perforating processing position is shortened, the length will not fall below the length to the perforating processing position in a case where the square back processing is not performed.

As another embodiment, instead of acquiring the dimension of the square back portion from the information table, it may be possible to acquire a certain effect by merely displacing the linear perforation processing position for a fixed length regardless of the number of sheets in a case where the square back processing is set to be performed. Further, an arithmetic processing may performed based on a sheet type information including the grammage information of the sheet and the number of sheets information, and for example, the length of the square back is elongated as the grammage increases, and is shortened as the grammage decreases. Moreover, the length of the spine tends to be elongated as the number of sheets of the booklet increases. Further, in a case where the sheet type information indicates a sheet subjected to processing such as coated paper, or a synthetic paper made of resin, the thickness increases similarly as the grammage increases, and the rigidity also increases, such that the length of the square back tends to be elongated.

Further, automatic adjustment of the perforation position based on the execution information of square back processing can be confirmed by the length from the fold created by the bookbinding processing to the perforation position being elongated corresponding to the square back processing performed to the sheet positioned on the frontmost side, or outermost side, in a case where a predetermined number of sheets, such as 20 sheets, of a predetermined sheet type, such as normal paper, is subjected to a bookbinding processing and a square back processing, compared to the length from the fold created by the bookbinding processing to the perforation position performed to the sheet positioned on the frontmost side, or outermost side, in a case where a predetermined number of sheets, such as 20 sheets, of a predetermined sheet type, such as normal paper, is subjected to only the bookbinding processing.

As another embodiment, instead of acquiring the dimension of the spine portion by the square back processing, it may be possible to perform the adjustment of the perforation position based on the length by which the spine of the booklet projects from the second folded sheet bundle conveyance roller pair 812a and 812b while performing the square back processing.

The embodiments described above have been illustrated based on a case where a perforating processing such as forming of punched holes or linear perforation is carried out to the sheets, but a similar effect may be realized by applying the technique to a creasing process performed to sheets. The creasing process in this case is carried out to provide a creasing to a position that differs from the spine portion of the square back position to realize an effect of enabling the front page and other pages of the booklet to be turned easily.

Even in the case of the creasing process, by performing similar control as the perforating processing described above, the operator can enter the length recognizing that the length is from the edge of the square back portion to the crease position, by displaying the square back portion and displaying that the length to be entered is from the edge portion K of the square back portion to the crease position when the creasing process is to be performed at a position that differs from the square back position of the booklet to be subjected to the square back processing.

The present disclosure provides a system configured to perform both the square back processing and the linear perforation processing to a booklet.

The present disclosure can be realized by providing a program that realizes one or more functions of the embodiments mentioned above via a network or a storage medium to a system or an apparatus, and having one or more processors of the apparatus read and execute the program. Further, the present disclosure can be realized by a circuit, such as an ASIC, for performing one or more functions. Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

### Industrial Applicability

The present disclosure can be applied to an image forming system for creating booklets.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. An image forming system comprising:
an image forming portion configured to form an image on a sheet;
a linear perforation processing portion configured to perform a linear perforation processing of forming a linear perforation on the sheet on which the image has been formed by the image forming portion;
a bookbinding processing portion configured to perform a bookbinding processing including binding and folding to a plurality of sheets including the sheet on which the linear perforation processing has been performed by the linear perforation processing portion;
a square back processing portion configured to perform a square back processing of forming a square back portion on a spine of a booklet formed by the bookbinding processing portion; and
an adjustment portion configured to adjust a position at which the linear perforation processing portion forms the linear perforation, based on an execution instruction for the square back processing.

2. The image forming system according to claim 1, wherein the adjustment portion is configured to adjust the position at which the linear perforation processing portion forms the linear perforation according to a type of sheet and a number of sheets constituting the booklet.

3. The image forming system according to claim 1, wherein the adjustment portion is configured to adjust the position at which the linear perforation processing portion forms the linear perforation such that a length from a fold position where a plurality of sheets is folded in the bookbinding processing to a position at which a linear perforation is formed on an outermost sheet of a booklet formed using a first mode is longer than that of a booklet formed using a second mode, the first mode being a mode in which the linear perforation processing is performed on a sheet to be the outermost sheet of the booklet and the square back processing is performed on the booklet, the second mode being a mode in which the linear perforation processing is performed on a sheet to be the outermost sheet of the booklet and the square back processing is not performed on the booklet.

4. An image forming system comprising:
an image forming portion configured to form an image on a sheet;
a perforating processing portion configured to perform a perforation processing of forming a perforation on the sheet on which the image has been formed by the image forming portion;
a bookbinding processing portion configured to perform a bookbinding processing including binding and folding to a plurality of sheets including the sheet on which the perforating processing has been performed by the perforating processing portion;
a square back processing portion configured to perform a square back processing of forming a square back portion on a spine of a booklet formed by the bookbinding processing portion; and
an adjustment portion configured to adjust a position at which the perforating processing portion forms the perforation based on an execution instruction for the square back processing.

5. The image forming system according to claim 4, wherein the adjustment portion is configured to adjust the position at which the perforating processing portion forms the perforation according to a type of sheet and a number of sheets constituting the booklet.

6. The image forming system according to claim 4, wherein the adjustment portion is configured to adjust the position at which the perforating processing portion forms the perforation such that a length from a fold position where a plurality of sheets is folded in the bookbinding processing to a position at which a perforation is formed on an outermost sheet of a booklet formed using a first mode is longer than that of a booklet formed using a second mode, the first mode being a mode in which the perforation processing is performed on a sheet to be the outermost sheet of the booklet and the square back processing is performed on the booklet, the second mode being a mode in which the perforation processing is performed on a sheet to be the outermost sheet of the booklet and the square back processing is not performed on the booklet.

7. An image forming system comprising:
an image forming portion configured to form an image on a sheet;
a creasing processing portion configured to perform a creasing processing of forming a crease on the sheet on which the image has been formed by the image forming portion;
a bookbinding processing portion configured to perform a bookbinding processing including binding and folding to a plurality of sheets including the sheet on which a creasing processing has been performed by the creasing processing portion;
a square back processing portion configured to perform a square back processing of forming a square back portion on a spine of a booklet formed by the bookbinding processing portion; and
an adjustment portion configured to adjust a position at which the creasing processing portion forms the crease based on an execution instruction for the square back processing.

8. The image forming system according to claim 7, wherein the adjustment portion is configured to adjust the position at which the creasing processing portion forms the crease according to a type of sheet and a number of sheets constituting the booklet.

9. The image forming system according to claim 7, wherein a length from a fold position where a plurality of sheets is folded in the bookbinding processing to a position at which a crease is formed on an outermost sheet of a booklet formed using a first mode is longer than that of a booklet formed using a second mode, the first mode being a mode in which the creasing processing is performed on a sheet to be the outermost sheet of the booklet and the square back processing is performed on the booklet, the second mode being a mode in which the creasing processing is performed on a sheet to be the outermost sheet of the booklet and the square back processing is not performed on the booklet.
